(19) United States
(12) Patent Application Publication
(10) Pub. No.: US 2004/0193488 A1
(43) Pub. Date: Sep. 30, 2004

(54) Method and system for advertising over a data network

(76) Inventors: Denis Khoo, Los Angeles, CA (US); Raymond F. Ratcliff III, Plano, TX (US); Francis A. Benevento II, Palm Beach, FL (US); Qian Huang, Rockville, MD (US)

Correspondence Address: Supervisor, Patent Prosecution Services, PIPER RUDNICK LLP, 1200 Nineteenth Street, N.W., Washington, DC, 20036-2412, US

(21) Appl. No.: 10/738,991

(22) Filed: Dec. 19, 2003

Related U.S. Application Data
(63) Continuation-in-part of application No. 09/625,832, filed on Jul. 26, 2000.
Application No. 09/625,832 is a continuation-in-part of application No. 09/487,120, filed on Jan. 19, 2000, now Pat. No. 6,434,747.

(51) Int. Cl. G06F 17/60

(52) U.S. Cl. 705/14

(57) ABSTRACT

A method and system for statistics-based individualized advertising over a network in which an advertiser provides to a content distributor one or more constraints defining the characteristics of desired target users and the manner by which the advertisement is to be delivered. The content distributor determines an estimated price based on statistics computed based on target users selected and the advertising periods allocated based on the constraints and individualized content delivery.

The present invention is a continuation-in-part of U.S. Ser. No. 09/625,832 filed Jul. 26, 2000, the contents of which are incorporated herein in their entirety.

### BACKGROUND OF THE INVENTION

1. Field of the Invention

The present invention relates generally to a method and system for advertising over a network. Specifically, it is related to statistics-based individualized advertising over a network during transmission. The present invention relates generally to a method and system for advertising over a network. Specifically, it is related to statistics-based individualized advertising over a network during transmission. The present invention is a continuation-in-part of U.S. Ser. No. 09/625,832 filed Jul. 26, 2000, the contents of which are incorporated herein in its entirety.

2. Description of Related Art

The delivery of advertisements to viewers of television programs has been based on an inefficient and wasteful model that often does not deliver an advertisement to a desirable audience. That is, the present paradigm for delivery of advertisements does not direct an advertisement to only those users who should be targeted for that advertisement. As a consequence, the price paid by an advertiser to put up an advertisement includes the costs to send the advertisement to users who do not have any interest in the advertisement. In addition, for such uninterested users, it may be annoying to have to receive an undesired advertisement.

All these may constitute significant waste and inefficiency. This is explained with reference to FIG. 1 (Prior Art).

FIG. 1 (Prior Art) provides an example illustrating a current advertising model. The example shown in FIG. 1 relates to placing an order for advertising a feminine product from a company producing feminine hygiene products. Assume that the manufacturer (or the company) wants the advertisement for the feminine product to be viewed by 100,000 women between the ages of 35 and 50. Such wish can be translated into “demographic” constraints such as a number constraint (100,000 individuals), a gender constraint (women), and an age constraint (between 35 and 50). This is illustrated in box 5 of FIG. 1. Then at box 10, the content distributor or another entity on the chain from initialization to receipt may research scheduled programs (e.g., television shows) to determine which would be expected to satisfy, in full or in a significant portion, the demographics requested by the feminine product company at box 5. For example, the content distributor may identify a scheduled program about women's tennis.

According to the scheduled reach of the women's tennis program, a cost per thousand (CPT) may be calculated, at box 15, as a function of the most significant demographic associated with the viewing audience. Even though not all television shows satisfy the exemplary demographics constraints (number (100,000), gender (women) and age range of (35-50)), a particular television show may be deemed as most suitable because it substantially satisfies those demographics constraints. Based on the CPT, the content distributor may then calculate a price, at box 20, for delivering a 30 second advertisement for the feminine product company with the identified women's tennis program. For example, it may charge $10,000 for a 30-second advertising spot (i.e., $100 CPT). If the number of viewers is determined to be 360,000, at box 23, then the cost for delivering the advertisement to each individual household during the women's tennis program is $0.02778, as shown in box 25.

The waste with the pricing model shown in prior art FIG. 1 is explained by reference to boxes 35, 40 and 45, which demonstrate the demographics of the individuals that actually view the advertisement (box 35), the cost per group of individuals (box 40) based on the $10,000 charge by the content distributor and the inefficiency analysis (box 45) that results from using this pricing model. Box 35 describes six different groups of individuals who actually viewed the advertisement. Specifically, 125,000 women between the ages of 35 and 50 (box 35-1) viewed the advertisement, however, individuals with different, non-targeted demographics also viewed the advertisement. Those individuals include 75,000 women between the ages of 20 to 35 (box 35-2), 25,000 women who are teenagers (box 35-3), 75,000 men ages 35 to 50 (box 35-4), 50,000 men ages 20 to 35 (box 35-5) and 10,000 men in their teens (box 35-6). Essentially, the advertisement was placed with this television show (e.g. women's tennis) based on the 125,000 women ages 35 to 50 . However, the remaining viewers (boxes 35-2, 35-3, 35-4, 35-5, 35-6) are not individuals to whom the feminine product company wanted to show the advertisement, yet the feminine product company is paying for those non-targeted individuals.

The amount that the feminine product company is paying for each group of individuals is shown in box 40. The costs per group of individuals as shown in box 40 are arbitrary costs based on the percentage of viewers of the total viewing audience multiplied by the $10,000 cost per thousand. Thus, in box 40, the 125,000 women ages 35 to 50 have a cost of $3,472 for the group shown while the other costs for the non-targeted individuals is also directly proportional to the percentage of the number of individuals who see the advertisement (box 35) to the total viewers (360,000). In box 45, the inefficiency analysis is shown where only the costs of the group of the 125,000 women ages 35 to 50 (box 35-1) are accurate and all the remaining individuals viewing the tennis match are wasted. In conclusion, only $3,472 of the $10,000 total costs for all individuals is accurate, resulting in a waste of 65.3%. This correlates to a waste or $6,528 of the $10,000 paid for the advertisement because only approximately 35% of the individuals viewing the advertisement were in the target audience.

Prior art FIG. 1 exemplifies the limitations in the prior art in that estimates based on projected group demographics are inefficient and wasteful. A need exists for an advertisement system that targets the advertising to particular individuals rather than to a group. In addition, the feminine product company is paying the same costs per individual for all the 125,000 women between the ages 35 and 50, when the women closer to a particular age in that range (e.g., 35 years old) may be a better target for the company than women at the other end of that range (e.g., 50 years old) and some households may have more targets than others (e.g., three teenage girls for a jeans commercial). Therefore, there is a further need to be able to highly individualize the targeted audience on a person by-person basis rather than on a group basis.

### BRIEF DESCRIPTION OF THE DRAWINGS

The invention claimed and/or described herein is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 (Prior Art) provides an example illustrating the conventional advertising model;

FIG. 2 depicts an overall framework that supports a statistics-based individualized advertising scheme over a network, according to embodiments of the present invention;

FIG. 3 illustrates exemplary types of constraints used to generate and deliver individualized advertisement during transmission of content, according to embodiments of the present invention;

FIG. 4 depicts an exemplary internal functional block diagram of a content distributor according to embodiments of the present invention;

FIG. 5 depicts an exemplary internal functional block diagram of an information processor of a content distributor, according to an embodiment of the present invention;

FIG. 6 depicts an exemplary internal functional block diagram of a customer manager of a content distributor, according to an embodiment of the present invention;

FIG. 7 depicts an exemplary internal functional block diagram of an advertising period allocator of a content distributor, according to embodiments of the present invention;

FIG. 8(a) illustrates exemplary types of information contained in an individualized delivery schedule for content embedded with an individualized advertisement, according to embodiments of the present invention;

FIG. 8(b) illustrates exemplary types of statistics that may be estimated to characterize a proposed delivery of advertisement according to an embodiment of the present invention;

FIG. 9 depicts an exemplary internal functional block diagram of a pricing mechanism of a content distributor according to an embodiment of the present invention;

FIG. 10(a) illustrates an exemplary pricing scheme to estimate a price for delivering an advertisement to target users, according to an embodiment of the present invention;

FIG. 10(b) illustrates an exemplary discrete acceleration rate function according to an embodiment of the present invention;

FIG. 10(c) illustrates an exemplary continuous two-dimensional acceleration schedule function according to an embodiment of the present invention;

FIG. 10(d) illustrates exemplary types of continuous one-dimensional acceleration schedule functions according to an embodiment of the present invention;

FIG. 10(e) illustrates an exemplary scaled acceleration function used in controlling a premium level in computing a price for delivering an individualized advertisement, according to an embodiment of the present invention;

FIG. 11 illustrates exemplary feedback statistics characterizing a delivery of an advertisement to target users, according to an embodiment of the present invention;

FIG. 12(a) depicts an exemplary internal functional block diagram of a mechanism to adjust an estimated price for delivering an advertisement to target users, according to an embodiment of the present invention;

FIG. 12(b) illustrates an exemplary adjustment schedule function comprising a plurality of adjustment scale functions, each of which corresponding to a discrete degree of discrepancy, according to an embodiment of the present invention;

FIG. 13 depicts an exemplary internal functional block diagram of an advertiser, according to embodiments of the present invention;

FIG. 14 is a flowchart of an exemplary overall process, in which an advertisement is ordered and delivered in a statistics-based individualized advertising scheme according to embodiments of the present invention;

FIG. 15 is a flowchart of an exemplary process, in which desired target users are identified based on constraints, according to an embodiment of the present invention;

FIG. 16 is a flowchart of an exemplary process, in which advertising periods are allocated in an individualized manner, according to an embodiment of the present invention;

FIG. 17 is a flowchart of an exemplary process, in which a price for delivering an advertisement to desired target users is determined according to an embodiment of the present invention;

FIG. 18 is a flowchart of an exemplary process, in which a price for delivering an advertisement to an individual target user is determined according to an embodiment of the present invention;

FIG. 19 is a flowchart of an exemplary process, in which an estimated price for delivering an advertisement to target users is adjusted based on feedback statistics, according to an embodiment of the present invention;

FIG. 20 is a flowchart of an exemplary process, in which an advertiser conducts individualized advertising according to embodiments of the present invention; and

FIG. 21 is a flowchart of an exemplary process, in which a content distributor conducts individualized advertising according to embodiments of the present invention.

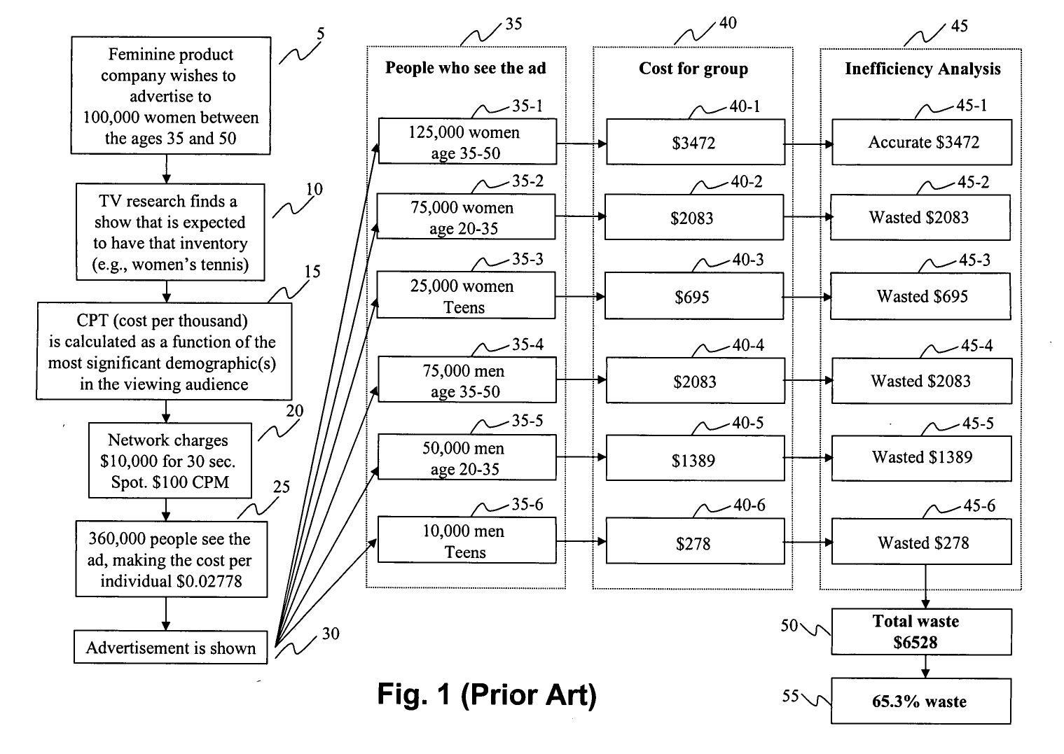

### DETAILED DESCRIPTION OF A PREFERRED

### EMBODIMENT OF THE INVENTION

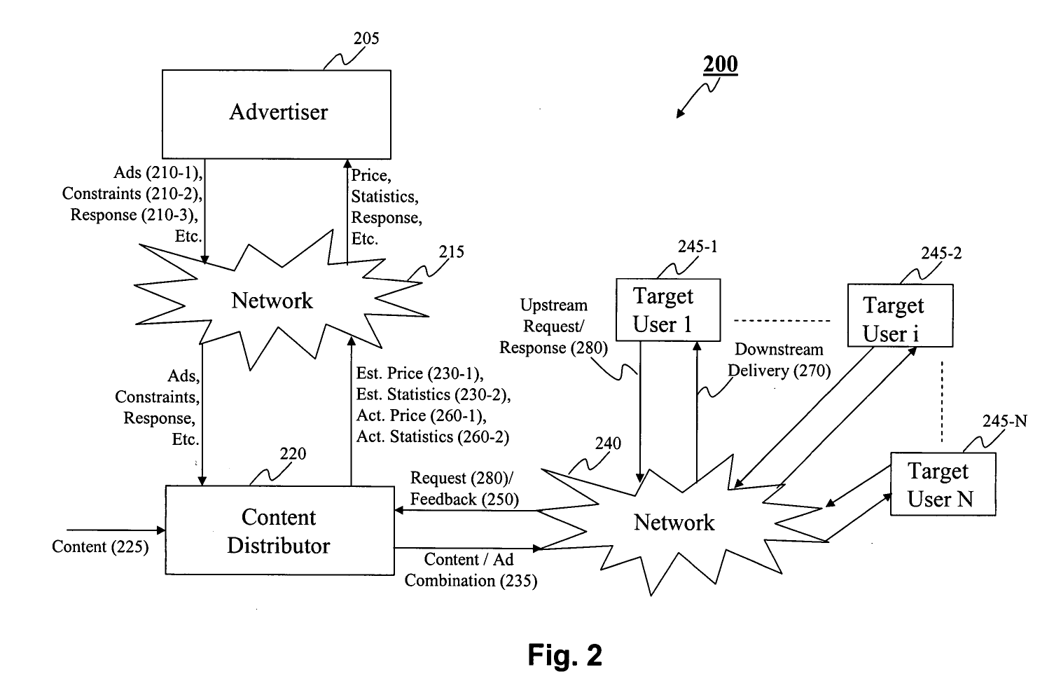

FIG. 2 depicts an overall framework 200 that supports a statistics-based individualized advertising scheme over a network, according to embodiments of the present invention. The framework 200 comprises an advertiser 205, a content distributor 220, and a plurality of target users 245-1, 245-2, . . . , 245-N. The advertiser 205 communicates, over a network 215, with the content distributor 220 regarding delivering an advertisement to the plurality of target users 245-1, 245-2, . . . , 245-N who are desired by the advertiser 205. If there is an agreement between the advertiser 205 and the content distributor 220 on a particular delivery, the content distributor 220 delivers the advertisement, with or without content, to the target users, over a network 240. The network 215 and the network 240 may or may not be the same network. Both networks (215 and 240) represent a generic network, which may include a digital network, an analog network, the Internet, a wireless network, a proprietary network, a virtual private network, a local area network (LAN), a wide area network (WAN), a conventional information distribution network such as a newspaper/magazine distribution network, or any combination thereof.

The advertiser 205 is a party who may desire to send an advertisement to a selected group of users so that the positive impact of the advertisement can be optimized. An advertisement is defined to generally relate to any message, which a party (e.g., an advertiser) is willing to pay to have delivered. The advertiser 205 may correspond to an advertising agency, a business entity, an organization, or an individual. The content distributor 220 engages in the business of enabling access to content and is capable of delivering an advertisement to one or more users over the network 240. Delivery of an advertisement may be carried out alone or during transmission of some content other than the advertisement.

The content distributor 220 may be a content provider that produces its own content and distributes such content (e.g., The American Broadcasting Corporation, radio stations, or publishers for books/magazines/journals). In this case, the content provider/distributor may distribute its own content with or without advertisements embedded. The content distributor 220 may also be an information consolidator who gathers information from different sources and organizes the information in a fashion to enable content search and consumption (e.g., American On Line, Inc., Yahoo! Corp, Google Corp., or Excite Corp.). Alternatively, the content distributor 220 may also be a content portal that merely provides a gateway through which a user may reach certain content (e.g., an Internet Service Provider or ISP such as American On Line, Inc., Yahoo! Corp, Google Corp., or Excite Corp.).

The content distributor 220 may also be a content dealer that buys content at a volume price and sells it at a different price. In this case, the content distributor 220 buys content 225 from one or more sources and distributes the content according to some agreement. For example, a cable company such as AT&T Broadband, Inc. is such a content distributor. A source from where the content 225 is purchased may correspond to a content provider or another content distributor of the content of others. Furthermore, the content distributor 220 may correspond to a party that is both a content provider and a distributor of content of others. For instance, TimeWarner, Inc. acts not only as a content provider that creates its own content (e.g., movies) and distributes its own content but also as a content distributor (as a cable operator) that distributes content from other content providers such as ABC.

The content distributor 220 may deliver an advertisement to target users with or without content other than the advertisement. Content with which an advertisement is to be delivered to target users may correspond to either digital or non-digital content. Digital content may include television programs, Internet content, or any digital information delivered through a distribution channel (e.g., data sent via an electromagnetic carrier, data sent over the Internet, or data sent to a cellular phone through a wireless telecommunication network). Non-digital content may include any information that is distributed in a non-digital form. Although distributed in a non-digital form, such non-digital content may be nevertheless produced through a digital process. For example, newspapers or magazines, although in a printed form, may be designed or produced, prior to being printed, via a digital process. Non-digital content may also include information that is distributed in an analog form (e.g., radio). Similarly, some of such analog information may be originally generated via a digital process and later converted into an analog form.

An advertisement may be delivered to targeted users with or without content. In either scenarios, the advertisement or the content with advertisements may be delivered in different modes. They may be broadcast to users. For example, a local television station may broadcast ABC news in a region it covers with advertisements. A radio station may broadcast content with advertisements in a particular geographic area. The same radio station may also broadcast different content using different frequencies or to different target users located in different regions.

Content and/or advertisement may also be sent in a narrowcast mode. They may be sent to individual users according to their subscription (e.g., some users may subscribe to HBO or Wall Street Journal). They may also be sent to an individual user as a response to an on-demand delivery request from the individual user (e.g., pay per view, video on demand, or a book order). Depending on the mode of delivery, the same advertisement may be transmitted to target users with the same content (in a broadcast mode) or with dynamically determined different content (in a narrowcast mode). In addition, an advertisement may also be delivered, With or without content, to a target user based on a request made by the target user via upstream communication.

An advertisement 210-1 may correspond to a commercial advertisement or any message, which a party is willing to pay to have delivered. The advertisement 210-1 may be generated in different media forms such as digital or non-digital. A digital or non-digital advertisement may correspond to a multimedia form, video, audio, text, or other media forms, or any combination thereof. Similar to content, non-digital advertisement, although delivered in a non-digital form, may be produced originally in a digital form and later converted for delivery purposes. In addition, a digital advertisement may be converted to a non-digital form when a dynamic delivery environment requires so. A user may request a paper version of an advertisement in a newspaper even though a digital version of the newspaper is available from the Internet. Furthermore, an advertisement may be sent in a media form (e.g., audio) different from its original production form (e.g., multimedia form). For example, a user may make an on-demand request for an advertisement to be sent to his cellular phone (e.g., verifying an advertisement while driving on the road). In this case, even though the advertisement is originally produced in multimedia form (with both audio, video, and textual captions), to effectively deliver the advertisement to a receiving device that has limited bandwidth, the advertisement may be converted to audio media form first before the advertisement is sent to the user.

An advertisement may be sent without content or delivered to target users alone without other content transmitted at the same time. An advertisement may also be transmitted with content as either a separate part (e.g., before, after or during intermission in the content segment) or as a placement of the content (e.g., inserting Count Chocula at the breakfast table instead of Corn Flakes). An advertisement may be sent to a user as a separate pop-up advertisement from an Internet Portal (e.g., Yahoo) to a user. Such a pop-up advertisement may be sent as the user, for example, logs on (without content). It may also be sent with search result (with content) yet still as a separate entity. An advertisement may also be transmitted to a user with a movie the user ordered where the advertisement is displayed such as described above. To incorporate an advertisement into content, there may be two main considerations. One is with what content the advertisement is to be incorporated. Another consideration is in what manner the advertisement is to be incorporated.

A determination related to the first consideration (what content) may be related to the question of to whom the advertisement is to be delivered. Such a determination may be made according to, for example, the advertiser's geographic reach or target, the users' profile information (e.g., personal information, subscription, or preferences), the coverage of the content distributor, and users' on-demand requests. The determination may be made in an individualized, dynamic, and adaptive manner. Once the scope of the target users is determined, content to be associated with the advertisement may be accordingly determined (e.g., according to a scheduled content delivery or an on-demand requests).

The second consideration (how to incorporate an advertisement into a content) relates to such factors as the manner in which the advertisement is to be delivered and the associated costs. An advertisement may be a separate or interrupting segment or placed in the content itself. The decision may involve simply whether the advertisement is delivered before or after the content, or how advertisements are dispersed among content segments. Such decisions may turn on the availability of advertising periods from the content distributor's point of view, or the characteristics of the target users. For example, an advertiser may desire a certain number of repetitions of the advertisement per hour and certain durations for each single advertisement exposure. An advertiser may also impose a cap on the price based on economic considerations.

The content distributor may limit advertising periods to advertisers who historically have large budgets. The content distributor may consider certain groups of users to be more desirable than others for advertising certain products. For example, users with teenager children at home may be more valuable targets for advertisements on skateboards. Therefore, the content distributor may limit the access of advertisers who do not target teenagers or raise the price for those that do based on the number of teenagers in a given location. Information about users' low/high tolerance to advertising may be another consideration.

Another factor is the media form the advertisement is to take. Decisions associated with media type may be made based on the type of device receiving the advertisement. Certain devices may have limitations on, for example, bandwidth or processing. Audio may be preferred when a receiving device is a cellular phone and text may be preferred when the receiving device is a PDA.

An advertisement may be delivered with content adaptively in different media forms. For example, an advertisement may be incorporated into content in its original media form (e.g., multimedia) and conversion may be performed on-the-fly when a receiving device is identified. Alternatively, content with associated advertisement may be converted into different media forms off-line and then distributed depending on the receiving device type.

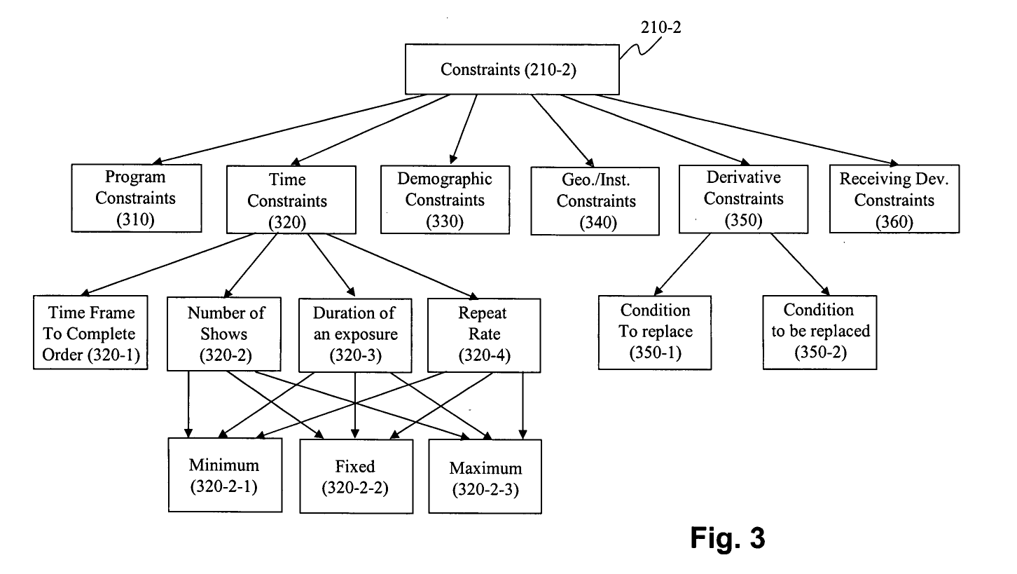

To achieve individualized advertising, the advertiser 205, who wishes to deliver an advertisement (210-1) to a selected group of users (target users) who satisfy certain desired criteria, may send one or more constraints (210-2) to the content distributor 220. The constraints 210-2 may characterize different aspects related to the scope and the manner by which the advertisement 210-1 is to be delivered. FIG. 3 illustrates exemplary types of constraints, according to embodiments of the present invention. The constraints 210-2 may comprise program constraints 310, time constraints 320, demographic constraints 330, geographic/institutional constraints 340, derivative constraints 350, and receiving device constraints 360. The program constraints 310, the demographic constraints 330, and the geographic/institutional constraints 340 may specify limitations related to the scope of the target users. The program constraints 310, the time constraints 320, the derivative constraints 350, and the receiving device constraints 360 may specify limitations on the manner in which the advertisement 210-1 is to be delivered.

The demographic constraints 330 may characterize target users' demographic features. For example, such information may include name, age, gender, income, address, hobbies, hours of television watched per day, or profession, or any other types of information associated with a target user that may be relevant for purposes of marketing and pricing, including the number of targets at a given reception location. The geographic constraints 340 may specify a desired geographic coverage of the advertisement (e.g., southern U.S. in winter season for a swim suit advertisement). The institutional constraints 340 may specify a desired scope of the reach in terms of institutional requirements. For example, an advertisement on educational equipment may be specified to be delivered to at least all the users connected to “.edu” domain names. The program constraints 310 may also be used to limit the scope of target users. For instance, an advertisement for alcoholic products may be specified to be delivered only with content that is not likely to be received, i.e., by people who are under 21 years old.

Through the time constraints 320, an advertiser may specify various parameters related to how the advertisement 210-1 is to be delivered. For example, such time constraints may be specified as a time frame limitation (320-1) to complete an order to deliver the underlying advertisement. Such a time frame limitation may be specified in various manners. A definite date may be provided to indicate that the advertisement has to be delivered prior to that date. For example, an advertisement for a sale day of a shopping mall may have to be delivered prior to the sale day. The time frame limitation may also be specified in terms of seasons (e.g., to deliver an advertisement to users only in winter seasons). A limitation on delivery season may be translated into both a time frame limitation and a geographic constraint. For instance, constraint to deliver an advertisement for a snow shovel product may indicate that the delivery is only to users who are located in winter regions. Such a constraint is translated into a geographic constraint (where winter is present) and a time frame limitation (only a few months in a year correspond to winter season).

Different types of constraints may interact and together they may specify dynamic conditions under which an advertisement is to be delivered. Consequently, deliveries of the same advertisement (under one order) to different regions/users may differ depending on whether the dynamic condition in each region/user meets the constraints. For example, an advertisement for a cold drink product may be delivered whenever local temperature reaches 85 degree. An advertisement for an alcohol product is delivered only to households that do not have children under 21 (a condition changing with time as children in different households grow older each year). Therefore, with these flexible constraints, a single order to deliver advertisement may be carried out over a period of time in different deliveries. The advertiser may also specify a time frame to limit the delivery time (e.g., within 72 hours).

Time related constraints may also be used to indicate other delivery parameters such as, but not limited to, number of shows (320-2) with which the advertisement is to be delivered, duration of a single exposure of the advertisement (320-3), and a repeat rate (320-4) by which the advertisement is to be exposed to target users within some understood unit in time (e.g., one hour) or unit in some other terms (e.g., one show). For each of the terms (i.e., number of shows, duration, and repetition rate), additional terms may also be specified to indicate how strictly such parameters have to be observed. For example, if no flexibility is allowed, the advertiser 205 may indicate that the specified delivery parameters are fixed (320-2-2). An alternative is to define a flexible range of the delivery parameters, provided in the form of a minimum value (320-2-1) and a maximum value (320-2-3) with respect to each delivery parameter. For instance, the advertiser 205 may indicate that the repeat rate may range from a minimum of two to a maximum of four exposures per hour.

The derivative constraints 350 may be used to specify conditions under which the advertisement may replace other advertisements (350-1) or may be replaced by other advertisements (350-2) when it is delivered to the target users. In content distributions, advertising periods may be recycled and in such situations, a new advertisement may be used to replace a previously inserted advertisement and may itself be replaced by other newer advertisements in the future. For example, when a local TV station rebroadcasts certain sports event, it may desire to replace the original national advertisement contained in the program with local advertisements to increase its revenue. Alternatively, the sponsor of an original advertisement that is replaced may explicitly prohibit such replacement or impose conditions under which its advertisement may be replaced (e.g., only after a national broadcast are local stations allowed to substitute their advertisements).

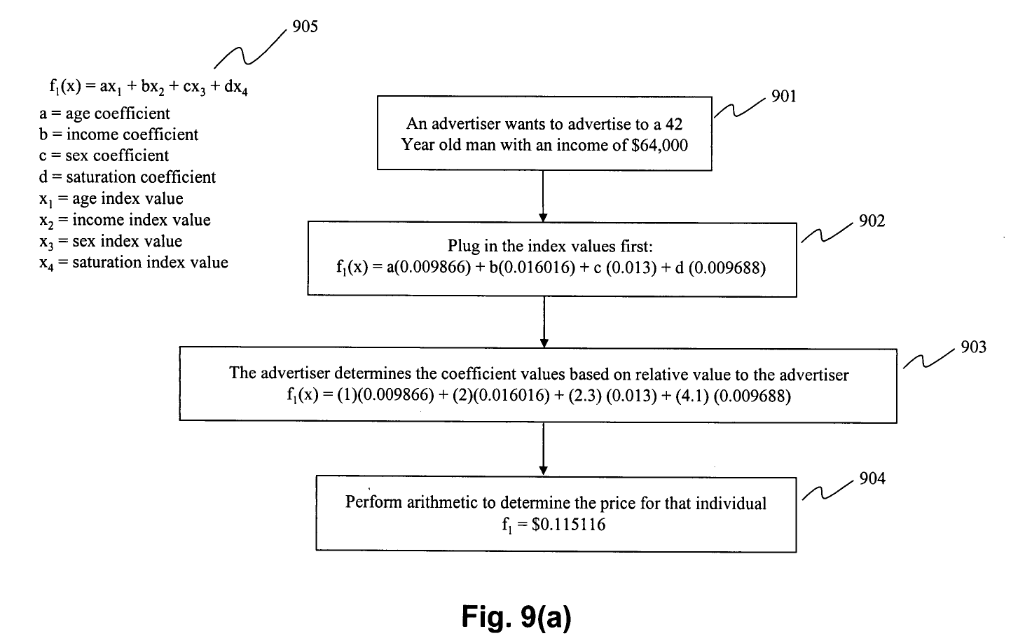

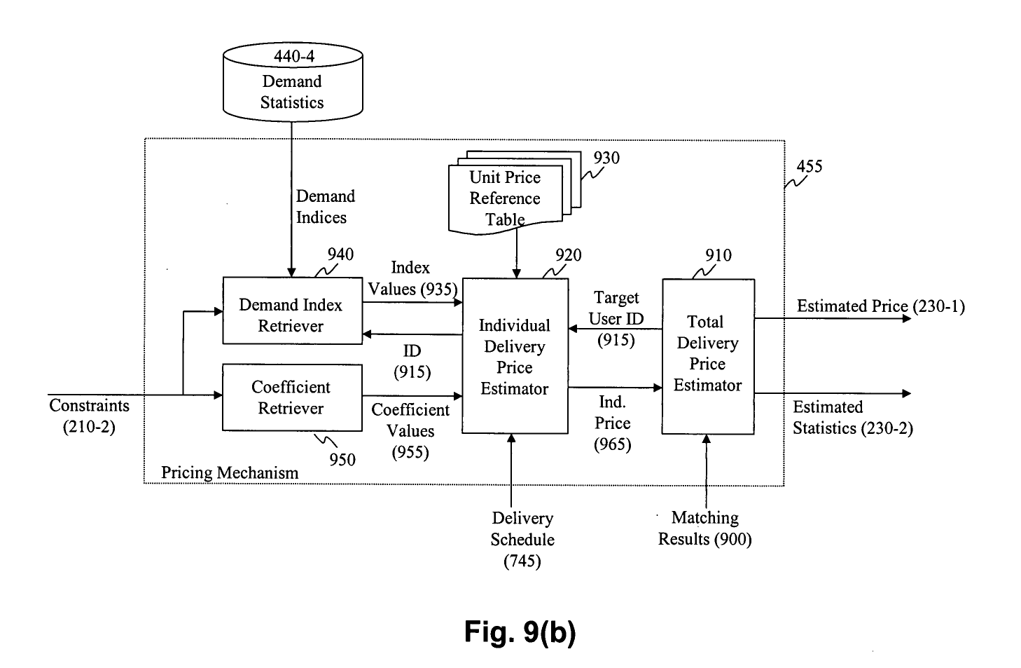

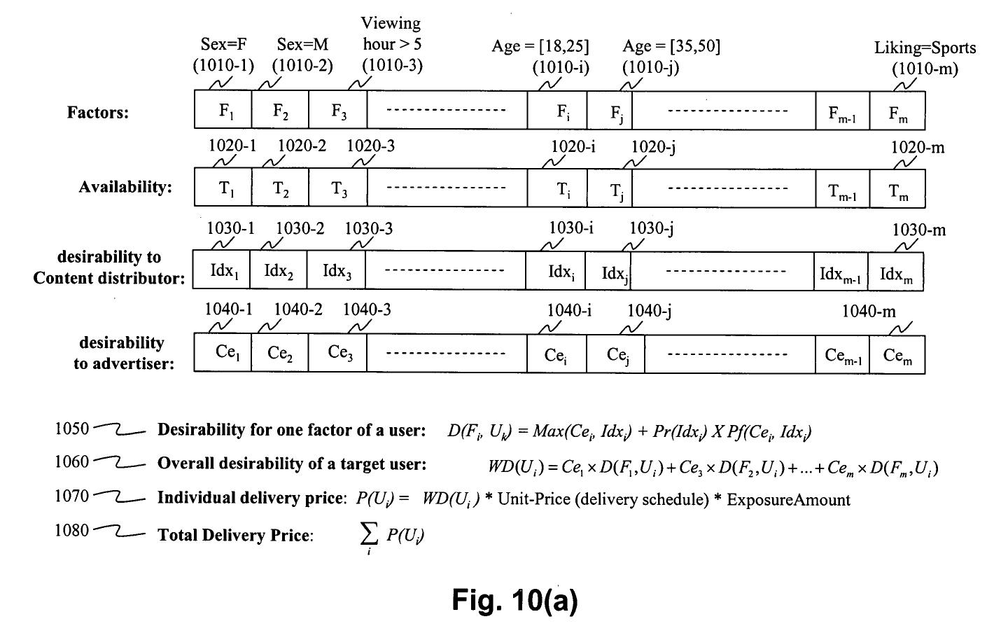

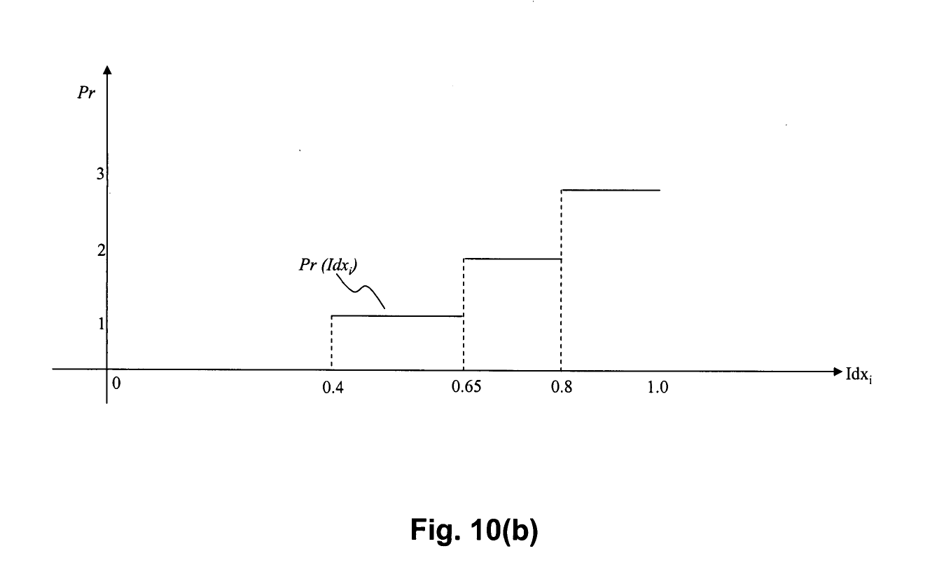

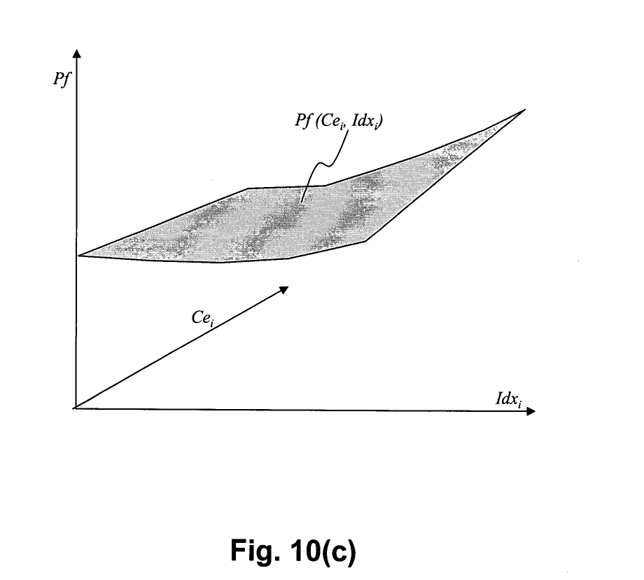

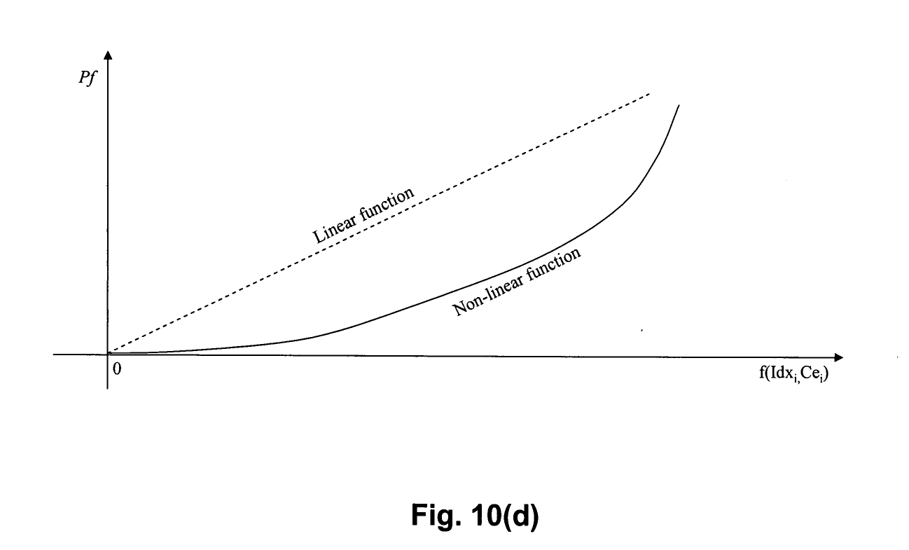

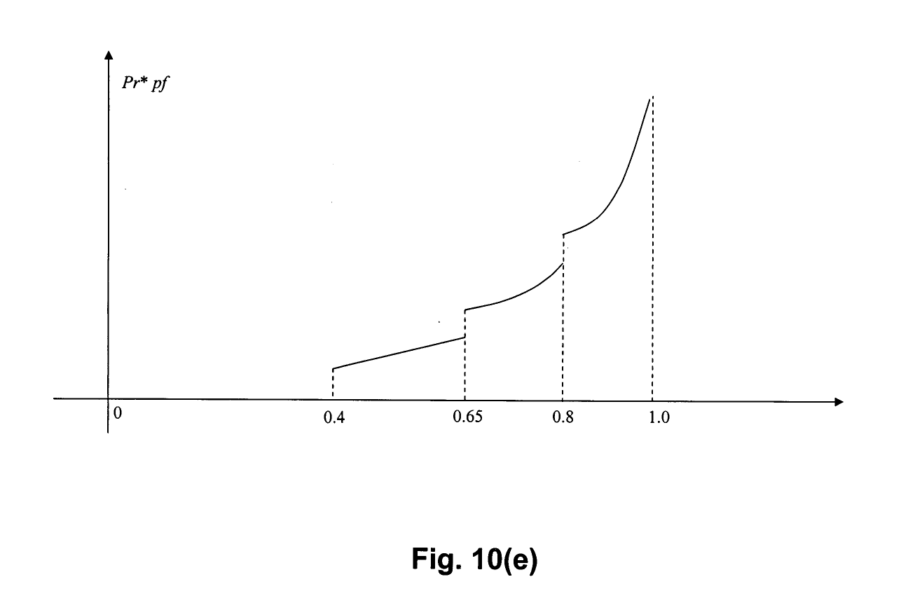

The prices for advertisements may vary. If an advertisement is inserted by replacing an existing advertisement, the advertiser may be required to pay a higher price. Similarly, an advertiser who explicitly prohibits its advertisement from being replaced may also be required to pay more to obtain an exclusive right. On the other hand, an advertiser whose advertisement is replaced may get some payment for each instance of replacement. The constraints 350-1 and 350-2 specify various different conditions related to how advertisement replacement may take place and with what terms. Such constraints may affect how the price is calculated (discussed below with reference to FIGS. 9 and 10(a)-(e).).

The receiving device constraints 360 may allow an advertiser to specify types of receiving devices to receive an advertisement. For example, although an advertisement may be created in multimedia form, an advertiser may nevertheless allow its advertisement to be delivered to a cellular phone in its audio form. Alternatively, an advertiser may require that textual information (e.g., captions) contained in its advertisement be displayed on the screen when its advertisement is delivered with a television program to a target user who is known to have hearing a disability.

In addition, the advertiser 205 may also provide a limit on the price to deliver the advertisement. All the constraints specified by the advertiser 205 may affect the price for delivering the advertisement. The content distributor 220 is to determine, based on the constraints 210-2, a delivery schedule for the advertisement that best match the given constraints. According to such a match, a corresponding estimated price (230-1) can be derived and sent, as an offer, to the advertiser 205 with estimated statistics (230-2) characterizing the proposed advertisement delivery schedule.

Upon receiving an offer for delivering the advertisement 210-1 at the estimated price 230-1, the advertiser 205 may assess the offer based on the estimated price 230-1 and the estimated statistics 230-2 before it accepts the offer. There may be some negotiations or correspondences between the advertiser 205 and the content distributor 220 through response information 210-3. For example, the advertiser 205 may revise its constraints if an initial estimated price is considered too high and the content distributor 220 may provide revised estimated price and statistics based on revised constraints. Ultimately, the advertiser 205 may accept or reject the offer. If the advertiser 205 accepts the offer, it may place an order to deliver the advertisement 210-1 to matched target users.

Upon receiving the order, the content distributor 220 delivers the advertisement, with or without content. Such delivery may or may not be directly to the target users. For example, the content distributor 220 may deliver the advertisement with content to one or more local hubs, where the advertisement associated with the content is further forwarded to the target users covered by individual hubs. Alternatively, the content distributor 220 may also transmit content with the advertisement to one or more local television stations from where the content with the advertisement may be further directed to the target users in the regions covered by the local stations and the transmission may take place according to local program schedules.

In addition to the above described offer-and-acceptance dealings between the advertiser 205 and the content distributor 220, there may be other alternative arrangement between the content distributor 220 and a buyer who ultimately orders an advertisement delivery from the content distributor 220 at the estimated price with the estimated statistics that meet a predetermined set of constraints. For example, the content distributor 220 may generate an advertisement delivery schedule on its own initiative and then solicit buyers. In this case, the advertiser 205 represents the ultimate buyer that accepts the estimated statistics that characterize the delivery without providing the constraints (the content distributor 220 does).

Alternatively, the advertiser 205 in the framework 200 may send its constraints to more than one content distributor (not shown in FIG. 2) to solicit offers or bids. Each of the content distributors who receive the constraints may make an offer, which amounts to a bid with an estimated price and associated estimated statistics characterizing the proposed advertisement delivery. The advertiser 205 may then select a bid that best meets its needs.

Furthermore, the advertiser 205 may communicate with the content distributor 220, providing constraints and subsequently receive an offer from the content distributor 220 for delivering the underlying advertisement in compliance with the constraints at an estimated price. The advertiser 205 may then forward the offer to a plurality of other advertisers (not shown in FIG. 2) to solicit buyers. Such buyers may place an order directly with the content distributor 220 or through the advertiser 205 who initially specified the constraints to the content distributor 220. For example, a franchise may have its own advertising agency in a particular geographic region, responsible for providing advertising services to all the franchisees in the region. In this case, the regional advertising agency for the franchise may communicate with a content distributor in the region, specifying the constraints to deliver a standard advertisement (e.g., an advertisement for an upcoming sale) and obtain an offer before forwarding the offer to all the franchisees in the region. When a particular franchisee in the region decides to run a sale, it may place an order directly with the content distributor for delivering the standard advertisement to estimated target users. It is understood that the descriptions below may apply to any of the arrangements described herein and other possible arrangements.

When the advertisement is delivered with content, since content transmitted to different target users may differ (individualized), the advertisement may be associated with different content and the delivery time may also differ with respect to different target users. In addition, sometimes, the delivery may not be carried out as scheduled due to various reasons. For instance, a particular program (content) scheduled to be delivered to a subgroup of target users may be delayed or canceled because an earlier program (e.g., a sports broadcast) runs longer than expected. A power outage in a particular region may make the delivery impossible. The occurrences of such unexpected events may affect the price that the content distributor 220 should actually charge the advertiser 205. Furthermore, a delay may shift the delivery to a time frame having a different price per unit time. The advertiser 205 should not be charged for a canceled delivery and the actual price should be computed based on the unit price associated with the delivery parameters such as delivery time and total exposure amount measured in terms of, for example, exposure amount in time (e.g., in case of delivery with a movie) or exposure in terms of space (e.g., how big a space is allocated for the advertisement in a magazine or newspaper). To acquire information related to the status of actual delivery, local operation entities (e.g., hubs or local television stations) may be required to provide some feedback (250) to the content distributor 220. Such feedback may include statistics related to the actual coverage (e.g., how many target users actually received the advertisement), the actual exposure amount to each target user (e.g., the actual length of each single exposure and the actual number of repetitions of the advertisement), or a characterization of target users' response to the advertisement.

After receiving the feedback 250, the content distributor 220 may adjust the estimated price 230-1 to produce an actual or adjusted price 260-1, which may be further sent, together with the actual statistics characterizing the status of the actual delivery, to the advertiser 205. The advertiser 205 may then receive a refund from the content distributor 220, if the advertiser 205 has paid prior to delivery for the advertisement.

The advertiser 205 may also analyze relevant information contained in the received actual statistics 260-2 (e.g., statistics describing the target users' responses) to assess the effectiveness or impact of the advertisement. Such analysis may also influence the advertiser 205 in determining how to formulate the constraints in the future to improve the cost effectiveness. For example, if feedback statistics indicate that a much larger percentage of the target users in the age group of [30, 35 ] responded positively to the advertisement and that almost none of the target users in the age group of [36, 50] have any response, the advertiser 205 may revise, for future presentation of the same advertisement (e.g., to a different region or country), the constraint on age range of desired target users from [30, 50 ] to [30, 35].

The embodiments described above correspond to a downstream advertising scheme, in which an advertisement is placed by an advertiser and transmitted to a target user through a downstream delivery (270). The framework 200 also facilitates an on-demand, upstream, and individualized advertising scheme. A target user (e.g., 245-1) may initiate an upstream request (280), sent to the content distributor 220, for a particular advertisement (e.g., Mercedes car or “cosmetics”) or a particular type of advertisement (e.g., advertisement related to a sale day in a local mall) satisfying a set of criteria (e.g., any advertisement for a sale in a local mall within one month period before a certain date). In this case, upon receiving an upstream request, the content distributor 220 may use the provided criteria to search, in the advertisement inventory stored at the content distributor 220, an advertisement that meet the criteria.

When an advertisement satisfying the given criteria is identified, the content distributor 220 may then deliver the advertisement to the requesting target user in a manner as described herein. For example, the advertisement may be delivered alone to the requesting user. It may also be delivered to the target user with certain content scheduled to be transmitted to the target user according to, e.g., the target user's subscription or a particular delivery time specified by the target user. For delivering an advertisement based on an upstream request, the content distributor 220 may charge, separately, the target user who requests the delivery or the advertiser who supplies the delivered advertisement or both.

Below, further details related to the content distributor 220 and the advertiser 205 are discussed separately.

Content Distributor

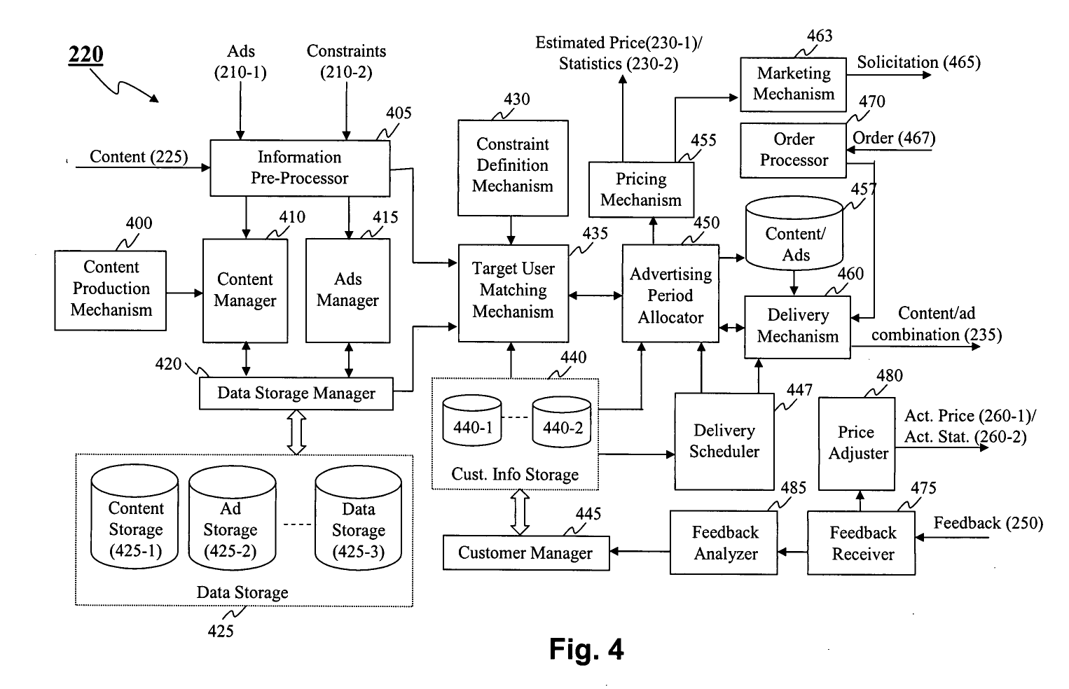

FIGS. 4-12 depict various exemplary functional block diagrams of different components of the content distributor 220 as well as relevant information structures used by the content distributor 220 in determining an advertisement delivery schedule that best matches the constraints 210-2.

FIG. 4 depicts an exemplary internal functional block diagram of the content distributor 220 according to embodiments of the present invention. The content distributor 220 comprises an information pre-processor 405, a target user matching mechanism 435, a pricing mechanism 455, delivery mechanism 460, a feedback receiver 475, and a price adjuster 480. The information pre-processor 405 may be responsible for pre-processing information received by the content distributor 220. Such received information includes content 225 from other sources, advertisement(s) 210-1 from an advertiser, and constraints 210-2 also from the advertiser that specify the conditions under which the advertisement is to be delivered.

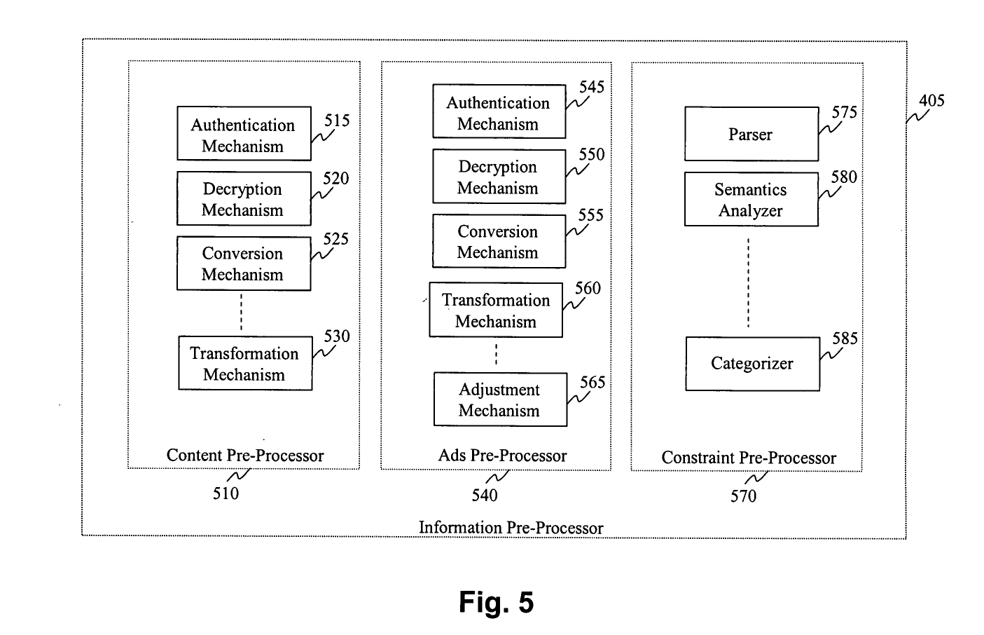

The pre-processed information, after processing, may be channeled to different components. For example, processed content may be forwarded to a content manager 410 that is responsible for interfacing with a data storage manager 420 to store content in and retrieve content from a data storage 425. The content manager 410 may also handle content storage and retrieval for content produced internally by a content production mechanism 400. This may occur when the content distributor 220 is also a content producer. Processed advertisements may be channeled to an advertisement manager 415 that is responsible for storing and retrieving advertisements from the data storage 425 through the data storage manager 420. The processed constraints are forwarded to the target user matching mechanism 435. Details related to the information pre-processor 405 are discussed with reference to FIG. 5.

The target user matching mechanism 435 is responsible for identifying target users according to constraints. The constraints may be received from either the information pre-processor when they are provided by an advertiser or from an internal constraint definition mechanism 430 through which the content distributor 220 may define constraints on its own initiative. The latter situation may occur when, for example, the content distributor 220 is also a content provider that distributes its content with advertisements or when the content distributor 220 is engaged in advertising operations.

Based on given constraints, the target user matching mechanism 435 may search its inventory (customer database) information stored in a customer information storage 440 managed by a customer manager 445. Such inventory information may include different types of information related to each user such as a profile characterizing the user (e.g., demographic information), subscription data, user request history, or billing status. Relevant information may be retrieved and compared with the constraints to identify matching target users.

When the advertisement is to be delivered during transmission of content, the content distributor 220 may also include an advertising period allocator 450 configured to allocate advertising period(s) in certain content in a manner that satisfies both the advertiser's constraints (e.g., deliver the advertisement within a certain time frame with a specified total exposure amount) and the content distributor's constraints (e.g., certain content is scheduled to be transmitted to certain users at a certain time). The advertising period allocator 450 may perform the allocation based on selected target users, determined by the target user matching mechanism 435, and delivery schedules for such target users, determined by a delivery scheduler 447 according to, for example, customer subscription/request.

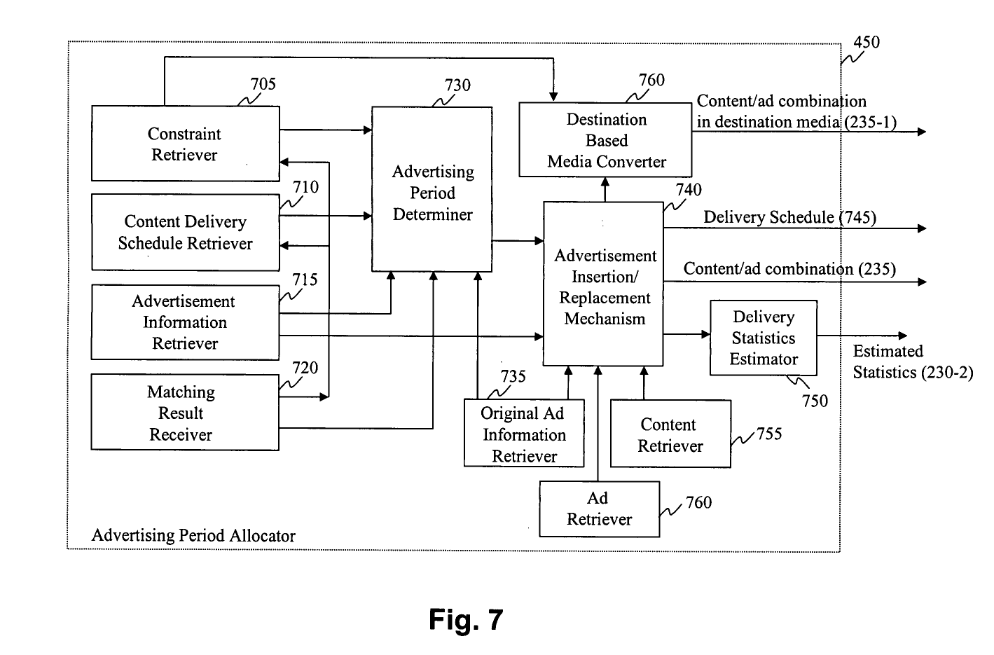

Once the advertising period is allocated, certain statistics may be estimated for the advertising period and such estimated statistics (230-2) are forwarded to the pricing mechanism 455 for price estimation. In addition, the advertisement may then be integrated with scheduled content using the allocated advertising period to generate the content/advertisement. Different media versions of the content/ad combination may also be generated. For example, an audio version may be generated in addition to a multimedia version (with video, audio, and text) so that it may be used to deliver the advertisement when a receiving device (e.g., a cellular phone) can effectively receive only audio signals. The content/ad combination may be stored, prior to delivery, in a content/ads storage 457. Details related to the advertising period allocator 450 are discussed with reference to FIG. 7.

The pricing mechanism 455 is configured to produce an estimated price 230-1 based on selected target users and, when the advertisement is delivered with content, other relevant statistics estimated based on the allocated advertising period. The estimated price 230-1, together with the estimated statistics 230-2, may then be sent to the advertiser. Details of the pricing mechanism 455 are discussed with reference to FIG. 9.

The content distributor 220 may also use the estimated price/statistics (230-1/230-2) to solicit buyers through a marketing mechanism 463. A delivery order processor 470 may be further configured to receive an order 467 to request a delivery of a particular advertisement. An order may be received from different sources. For example, the order 467 may come from an advertiser who accepts an offer prepared based on its constraints. The order 467 may also come from an advertiser who merely responds to a general solicitation for buying an advertisement delivery schedule characterized by estimated statistics at an offered price. As discussed earlier, such a solicitation may be made either by the content distributor 220 or by an advertiser who obtains an offer from the content distributor 220 and then solicit buyers on its own initiative. Furthermore, the order 467 may also be from a target user who sends an on-demand requests upstream asking for a particular advertisement that fits certain user specified constraints (e.g., an advertisement of a local mall related to a sale prior to certain date).

Upon receiving the order for delivering an advertisement, the content distributor 220 invokes a delivery mechanism 460 to transmit the advertisement to the target users. The delivery mechanism 460 may be capable of transmitting information in either a broadcast or a narrowcast mode. Depending on the mode of delivery, the delivery mechanism 460 may access relevant information to properly direct the transmission. For example, if the advertisement is to be delivered in a narrowcast mode (i.e., individualized delivery), the delivery mechanism 460 may access a delivery schedule associated with each target user (e.g., from the delivery scheduler 447), which may provide indicative information in terms of, for example, whether the advertisement is to be delivered with content, what content with which the advertisement is transmitted with, the delivery time, and the type of receiving device associated with the target user. Using such information, the delivery mechanism 460 may retrieve the appropriate version (e.g., audio version) of certain content/ad combination from the content/ads storage 457 and carry out the transmission using the appropriate destination corresponding to each specific target user.

The delivery mechanism 460 may also dynamically determine what is to be sent when. For example, it responds to an on-demand request from a target user (forwarded from the order processor 470) to deliver a certain type of advertisement. In this case, the delivery mechanism 460 may search the content/ads storage 457 and the delivery schedule with respect to the requesting target user to identify particular content that meets the user specified constraints. If the advertisement to be delivered with the content does not satisfy the user-specified constraints, the delivery mechanism 460 may invoke the advertising period allocator 450 which may further invoke the target user matching mechanism 435 to search for an advertisement meeting the user's request from the data storage 425 (through the data storage manager 420) to be inserted into the content. This is part of an upstream process, which runs in a reversed direction compared with a downstream process.

After an advertisement is delivered, the feedback receiver 475 may receive feedback information 250 characterizing the actual status of the delivery from various sources such as local content distributors (e.g., local television stations or local radio stations), local distribution operators (e.g., hubs), or target users (e.g., responses to a survey or an infomercial). The feedback information may characterize the actual delivery in terms of different aspects corresponding to the constraints based on which the delivery is scheduled. For instance, the feedback information may indicate the status of coverage (whether all desired target users actually receive the advertisement), timing (whether the delivery is actually on time as scheduled), adequacy of the exposure (whether the advertisement is cut or shortened in some way), or impact of the advertisement on individual target users (which target user responded in what way).

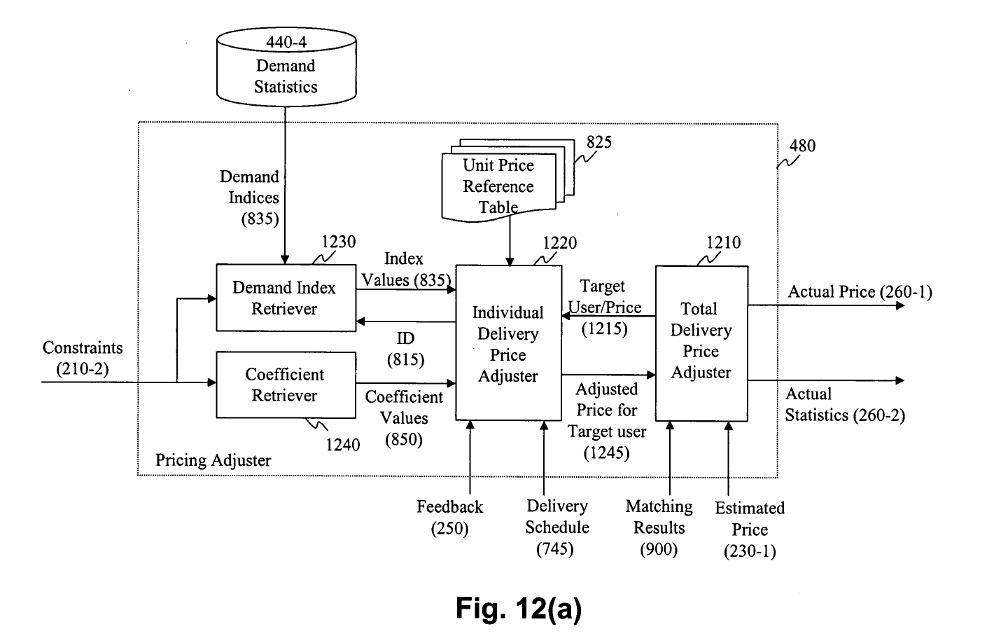

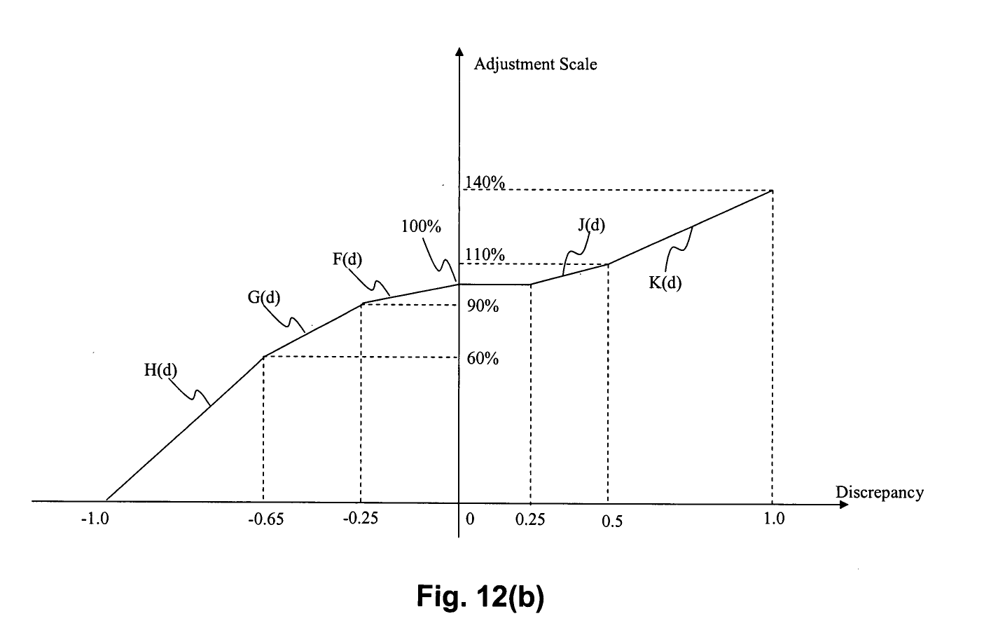

The price adjuster 480 may be invoked, upon receiving the feedback information 250, to adjust the original offered price when a discrepancy exists between the estimated statistics 230-2 (characterizing a scheduled delivery) and actual statistics (characterizing an actual delivery), if the sales agreement between the content distributor 220 and the advertiser who orders the delivery calls for price adjustment in such situations. The price adjuster 480 produces an actual price 260-1 based on the actual statistics 260-2 derived from the feedback information 250 and sends the actual price 260-1, together with the actual statistics 260-2, to the advertiser who orders the delivery. Details related to the price adjuster 480 are discussed with reference to FIG. 12.

The feedback information 250 may also be forwarded to a feedback analyzer 485 configured to carry out various data analyses on the feedback information. Results from such analysis may be utilized for purposes other than price adjustment. For example, the customer manager 445 may use statistics derived from the feedback information to update certain customer records. The advertiser may also desire to use such information to, for instance, assess the effectiveness of the advertisement, the cost effectiveness of the content distributor, the correlation between the constraints and the effectiveness of the advertisement with respect to different groups of target users, or to use the assessment as a guide to revise the constraints for future advertising (e.g., revise age group requirement from range [25,50] to [25,35] based on an assessment that majority of the target users from age group [25,35] responded positively while only a few target users from age group [36,50] responded positively).

Discussions related to different components of the content distributor 220 are provided below. FIG. 5 depicts an exemplary internal functional block diagram of the information pre-processor 405 according to an embodiment of the present invention. The purpose of the information pre-processor 405 is to transform received information into a form that can be internally handled by the content distributor 220. Although exemplary transformations are described herein, one skilled in the art may appreciate that when information is packaged in new ways, additional or different transformation mechanisms may be introduced. In FIG. 5, the information pre-processor 405 comprises a content pre-processor 510, an advertisement pre-processor 540, and a constraints pre-processor 570.

The content pre-processor 510 is responsible for converting content received into one or more forms. It may comprise, for example, an authentication mechanism 515, a decryption mechanism 520, a conversion mechanism 525, and a transformation mechanism 530. The authentication mechanism 515 may be responsible for ensuring the authenticity of the received content. For example, the content may be received with a signature, which can be authenticated to make sure that the content is indeed sent from a reliable source. The decryption mechanism 520 is responsible for decrypting the content if it is received in an encrypted form.

The conversion mechanism 525 may perform required operations to convert the received content into a particular form that can be used for possible further processing. For example, a motion picture received may be encoded (e.g., in MPEG-2 format) and the content distributor 220 may prefer to handle a decoded data stream. In this case, the conversion mechanism 525 may invoke an appropriate decoder (not shown) to derive a decoded data stream. Furthermore, the transformation mechanism 530 may be responsible for transforming received content in certain media into information in different media types. Media types may include, but are not limited to, multimedia form, video, audio, text, or any combination thereof.

Content may be received in a certain media form or source media form. The transformation mechanism 530 may generate the content in a certain destination media form. For example, a multimedia digital movie may simultaneously contain aligned video, audio, and text tracks. To enable delivery of the content to different receiving devices (e.g., cellular phone, handheld devices) in corresponding acceptable media forms, the transformation mechanism may be invoked to extract from the original multimedia content separate audio or text tracks as separate streams. Such extracted separate streams of different media types may be readily used to deliver the content in an appropriate media form required by different types of receiving devices (e.g., a cellular phone may be capable of receiving only audio stream when bandwidth is so limited).

The advertisement pre-processor 540 may comprise similar components as the content pre-processor 510 and components required for processing an advertisement. For example, it comprises an authentication mechanism 545, a decryption mechanism 550, a conversion mechanism 555, a transformation mechanism 560, and an adjustment mechanism 565. All components except the adjustment mechanism 565 in the advertisement pre-processor 540 may perform substantially the same functionalities as in the content pre-processor 510. The adjustment mechanism 565 may be responsible for making certain adjustments that are specially required for advertisements. For example, for any received advertisement, the adjustment mechanism 565 may be applied to turn up the power level of the sound by 5 dB relative to the average power level of the sound in normal content. It may be possible that the adjustment mechanism 565 may perform different types of adjustment to different types of advertisement.

The constraint pre-processor 570 is responsible for processing received constraints from advertisers and for deriving the semantics of the constraints in order to facilitate automatic identification of target users and automatic derivation of a delivery schedule for the advertisement that fully or partially satisfies the given constraints. The received constraints may be coded in some language such as HyperText Markup Language (HTML) or extensible Markup Language (XML). To understand the constraints, a parser 575 may be invoked to decode them. The parsed results may then be forwarded to a semantic analyzer 580, which may then extract specific elements of the given constraints. For example, requirements for delivering a swim suit advertisement to a particular age group (e.g., [18, 35]) in a particular geographic region (e.g., southern part of the U.S.A.) in a particular time window (e.g., winter season) may be expressed in XML. Each specific constraint may be encoded using a pre-defined markup. In this case, the parser 575 may recognize the markup language (XML) and extract the constraint from each markup section. The semantics analyzer 580 may then interpret the meaning of each extracted constraint.

The constraint pre-processor 570 may further include a categorizer 585 configured to classify constraints into different categories such as demographic constraints, geographic constraints, or time related constraints. Each category of constraints may be used by different components in determining a delivery schedule. For example, demographic and geographic constraints are used (by the target user matching mechanism 435) to identify to whom the advertisement is to be delivered, while time related constraints are used (by the advertising period allocator 450) to determine how the advertisement is to be delivered with content (e.g., with what content, at what time, in what manner). Some other components may also use several different categories of constraints such as the pricing mechanism 455 and the price adjuster 480.

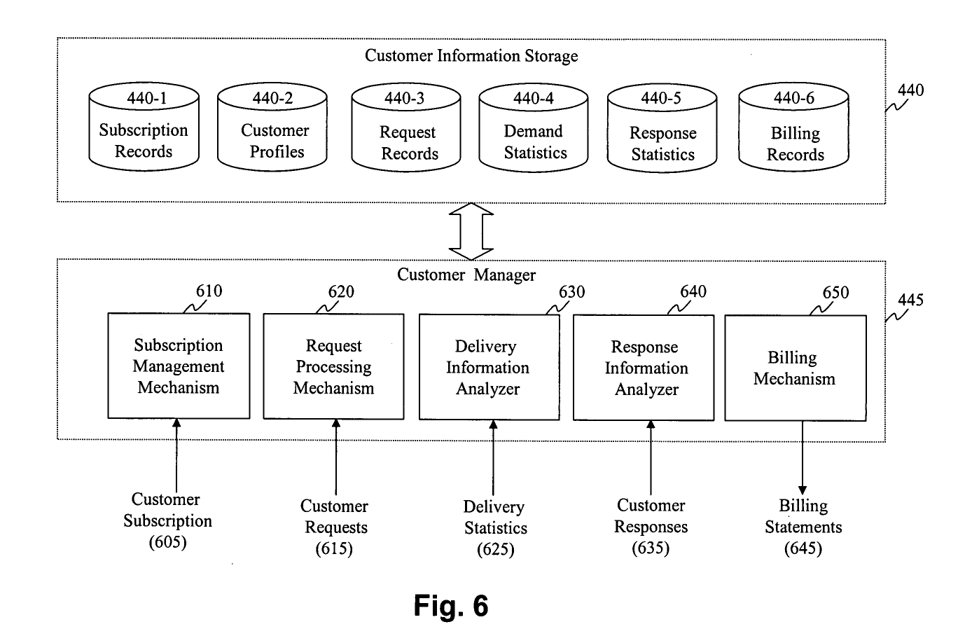

FIG. 6 depicts an exemplary internal functional block diagram of the customer manager 445 according to an embodiment of the present invention. The customer manager 445 is responsible for maintaining the customer information storage 440 with various types of customer related databases (e.g., a subscription record database 440-1, a customer profile database 440-2, a request record database 440-3, a demand statistics database 440-4, a response statistics database 440-5, and a billing database 440-6).

To properly maintain the customer information, the customer manager 445 may interface with the target users 245-1, 245-2, . . . , 245-N. It may also support an adaptation capability to enable the content distributor 220 to dynamically adapt to changing environments (e.g., users' preferences change with time). The customer manager 445 may comprise a plurality of sub-systems such as a subscription management mechanism 610, a request processing mechanism 620, a delivery information analyzer 630, a response information analyzer 640, and a billing mechanism 650. Each of the sub-systems may perform a specific function. The subscription management mechanism 610 may interact with users to receive customer subscription information (605) and then accordingly to enter a new subscription or update an existing subscription in the subscription record database 440-1. The subscription management mechanism 610 may interact with customers through a variety of interfaces such as telephone, interactive television, the Internet, or conventional postal mail via different networks.

The request processing mechanism 620 may be responsible for handling requests from subscribers. Similarly, interactions with subscribers may be performed through different interfaces via different networks. For each customer request (615), the request processing mechanism 620 may analyze the nature of the request and then forward the request to an appropriate channel. For example, if a customer request corresponds to an on-demand request for a particular content to be delivered in a short time, the request processing mechanism 620 may mark up the request as urgent and place it in a priority queue. The request processing mechanism 620 may also log each request in the request record database 440-3 and update the statistics related to user demand stored in the demand statistics database 440-4 (e.g., update a measure indicating which movie is in high demand according to the frequency of requests received for the movie).

The delivery information analyzer 630 may be responsible for analyzing delivery related statistics (625) contained in the feedback information 250. The response information analyzer 640 may be responsible for logging customer responses (635) contained in the feedback information 250 in the response statistics database and for performing further analysis on such response information. For example, different statistics may be computed to characterize the correlation between a high rate of positive responses to a particular advertisement with various user characteristics (e.g., profession, age, gender, etc.). The billing mechanism 650 is responsible for performing billing related operations based on information such as subscription, request record, etc. and issuing billing statements 645 to its customers.

The customer manager may differ from a conventional database manager in that it is capable of dynamically updating the information in the databases in an intelligent manner. The outcome of various analyses (e.g., performed by the request processing mechanism 620, the delivery information analyzer 630, and the response information analyzer 640) may be used, individually or collectively, to determine how to adapt, for example, the profiles of relevant users. Such outcomes may also be provided to the advertisers so that advertising strategies may also be adapted accordingly in future advertising activities (e.g., revise constraints to optimized cost effectiveness).

FIG. 7 depicts an exemplary internal functional block diagram of the advertising period allocator 450 according to an embodiment of the present invention. The advertising period allocator 450 may include an advertising period determiner 730, an advertisement insertion/replacement mechanism 740, and a delivery statistics estimator 750. The advertising period allocator 450 is invoked when the advertisement 210-1 is to be delivered with content scheduled to be transmitted to target users. To incorporate the advertisement 210-1 into content, the location(s) where the advertisement is to be incorporated in the content, or simply advertising period(s), may be first determined. This is achieved through the advertising period determiner 730. Once such period(s) are determined, the advertisement 210-1 may then be inserted into such allocated spot(s) or replace the advertisement originally inserted in the spot(s). This is achieved by the advertisement insertion/replacement mechanism 740. Information describing the incorporated advertisement (e.g., the advertisement will be delivered to whom, with what content, and with what exposure parameters to each target user) may be accordingly estimated. This is achieved by the delivery statistics estimator 750.

To determine the advertising period(s), the advertising period determiner 730 may retrieve different types of information. For instance, it may retrieve the target user matching result, generated by the target user matching mechanism 435 (FIG. 4) through a matching result retriever 720. The advertising period determiner 730 may also retrieve the advertiser's constraints through a constraint retriever 705 to access information relevant to the allocation (e.g., delivery time, single exposure amount, or repetition rate). Delivery schedules associated with individual target users may also be retrieved, through a delivery schedule retriever 710, so that the advertising period determiner 730 is aware of the content, which is to be delivered to a target user at the desired delivery time and with which the advertisement is to be integrated. Furthermore, the advertising period determiner 730 may also rely on information related to the advertisement itself (e.g., the length of the advertisement), retrieved through an advertisement information retriever 715, in determining the advertising period(s).

Using information from different sources, the advertising period determiner 730 determines the appropriate location(s) for advertising period(s) that best satisfy different given limitations. For example, if the advertisement is to replace an existing advertisement in the content scheduled to be transmitted to a target user, there may be a limited single exposure amount (e.g., 10 seconds per exposure) and a certain repetition rate (e.g., 3 times per hour). In this case, the advertisement may be tailored to fit the single exposure amount (i.e., 10 second per exposure) and one more advertising period may be added in the content to satisfy, for example, the advertiser's requirement for a repetition rate of 4 times per hour.

Once the advertising period(s) is determined, the advertisement insertion/replacement mechanism 740 may insert the advertisement into the advertising period(s). This may also involve replacing an existing advertisement at the same advertising period. This operation produces the content/ad combination 235 and an updated delivery schedule 745 if the original schedule has been revised (e.g., added one more advertising period to the original content to satisfy the constraints). To integrate the advertisement with the content, the advertisement insertion/replacement mechanism 740 retrieves the content and the advertisement through a content retriever 755 and an advertisement retriever 760, respectively.

The content/ad combination may also be transformed, via a destination based media converter 760, to produce a particular version of the content/ad combination that is in a media suitable for the intended receiving device. The determination of the specific media required may be made based on the constraints provided by the advertiser. According to the content/ad combination (which may be generated on an individual basis), delivery statistics may be estimated that characterize the proposed delivery. This may be achieved by a delivery statistics estimator 750.

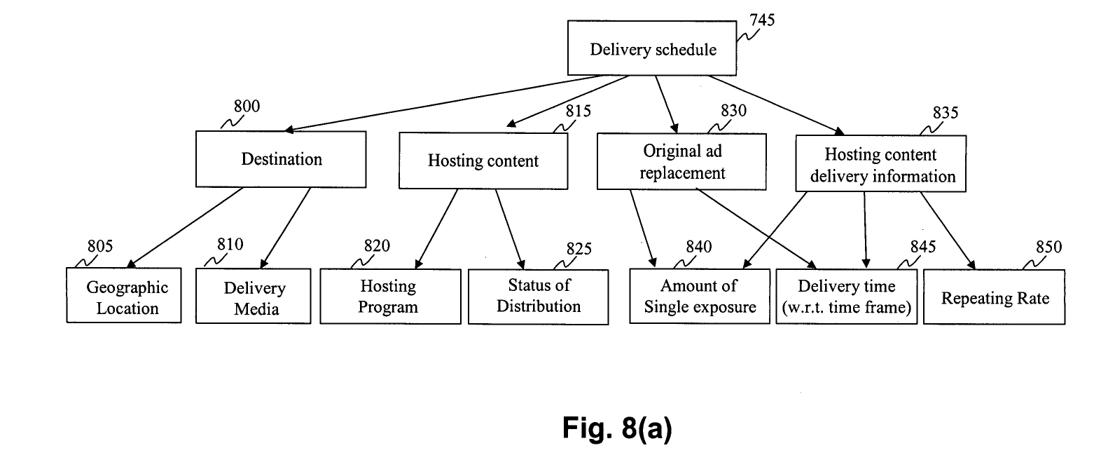

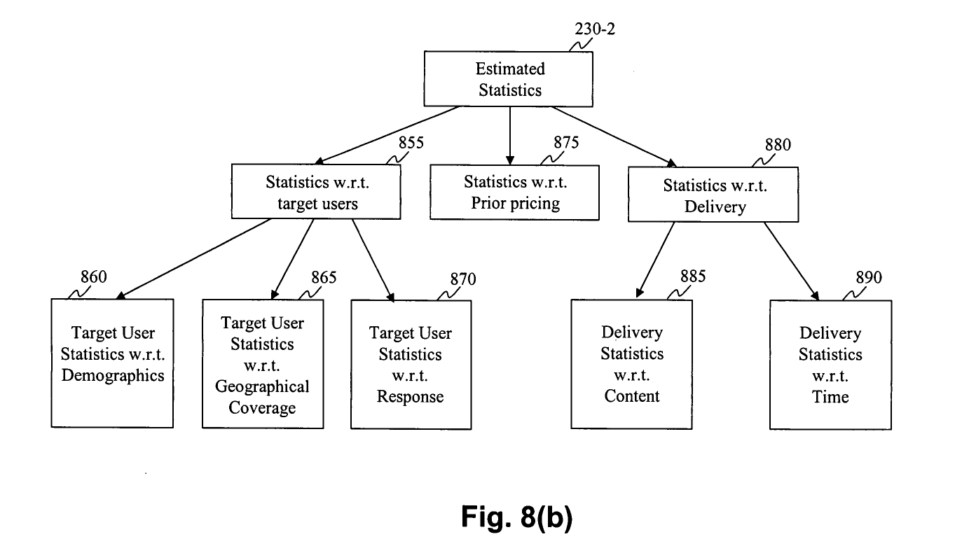

Exemplary types of information contained in an individualized delivery schedule are shown in FIG. 8(a) according to an embodiment of the present invention. A delivery schedule 745 may include information related to destination information 800, hosting content information 815 (if delivered with content), advertisement replacement information 830, . . . , and delivery information 835. The destination information 800 may further include geographic location 805 as well as delivery media 810. The former (805) may describe the address to where the advertisement (with or without content) is to be delivered, which may be a physical address or an electronic one (e.g., an ISP address, an email address, or a cellular phone number). Difference in delivery destination may affect price. For example, delivering an advertisement to one geographic region may cost more than delivering to a different geographic region. The latter (810) may indicate an appropriate media form in which the advertisement (and the content with which the advertisement is to be delivered) is to be transmitted. The appropriate media form may be determined according to a receiving device. For example, if the delivery address corresponding to a cellular phone, an audio media form may be appropriate to be used to deliver the advertisement with or without content.

The hosting content information 815 may be present when the advertisement is to be delivered with content. It may indicate the content in which the advertisement is embedded 820 and the distribution status 825 of the hosting content (e.g., second hand distribution which may lead to less expensive distribution cost and subsequently lower advertising rate). The advertisement replacement information 830 may describe whether there has been a replacement of original advertisement in the content and if there is, the corresponding replacement parameters. Such information may also be used to compute the cost of delivering the advertisement. If the advertisement has to be delivered by replacing some existing advertisement, the content distributor 220 may charge a higher rate on a replacement. In addition, if an original advertisement in a second hand distribution content is replaced, the cost may be lower.

The delivery information 835 may describe various time-related delivery information such as exposure amount 840, repetition rate 850 and delivery time 845. The replacement information may also contain similar features. As will be seen below, the delivery schedule is also used in pricing the advertisement (e.g., advertisements delivered at different times with different total exposure time will be charged differently).

FIG. 8(b) illustrates exemplary types of statistics that may be estimated to characterize a proposed delivery according to an embodiment of the present invention. Some of the measures may characterize the proposed advertising in terms of the target coverage (855). Some measures may be in terms of the delivery (880), and some may merely be in terms of the basis of pricing. In terms of the target coverage, various statistics may be computed based on the selected target users to assess, for example, how well the selected target users satisfy the given constraints in terms of demographics (860) or geographic limitations (865) with respect to the given constraints. Based on the selected target users, historical statistics associated with such users may also be provided with respect to, for instance, their past responses to similar advertisements (870). With respect to delivery, statistics associated with the content (885) in which the advertisement is embedded may be provided to indicate, e.g., the popularity of the programs. Estimated statistics with respect to delivery time (890) that may indicate a correlation between the rate of positive responses to different delivery times on similar advertisements may also be provided.

Statistics characterizing the derivation of the estimated price may be used by the advertiser, when receiving the estimated statistics, to assess or verify the offer. The content distributor 220 may compute its estimated price based on the same statistics employed in the pricing mechanism 455. There may be different pricing schemes that may be employed that utilize different statistics in computing an estimated price. FIG. 9(a) depicts one exemplary embodiment of a method for determining a price for delivering an advertisement. In FIG. 9(a), the predetermined constraints illustrated in 901 include an age of 42, a gender of male and an income of between $50,000 and $100,000 annually. In the individual inventory, a 42-year-old man with an income of $64,000 annually is located. An exemplary formula 905 is illustrated in FIG. 9(a) that determines a cost per individual based on two criteria, index value (e.g., X₁, X₂, X₃ and X₄ in 905 and the corresponding values in the parentheses in 902) and coefficients (e.g., a, b, c, and d in 905 and the corresponding values as inserted in 903).

It is important to note that the predetermined formula 905 is only one embodiment of the type of predetermined formulas that may be used to determine a cost per individual in the individual inventory. In essence, the predetermined formula 905 may be any formula that determines the demand on the individuals in the individual inventory. Such a demand may be based on the supply and demand of the specific individuals contained in the individual inventory, as well as the supply and demand from the advertiser. In FIG. 9(a), the index values are first inserted at 902 for Xₗ, X₂, X₃ and X₄ . These index values may be determined by the relative importance of the individual in the individual inventory to the content distributor 220. That is, an individual in the individual inventory may have a higher or lower index value based on the demand for the individual by the content distributor 220 with certain demographics in higher demand.

The demand for an individual from the advertiser's perspective may correspond to a weighted significance upon which the predetermined formula is based. The weighted significance is defined as the degree of significance represented by the coefficient values that is in turn computed based on the target individual's demand. In one embodiment, that demand may be based on the amount of time available for the target individual to receive an advertisement. Thus, if an individual is age 35 and male, for example, many advertisers may want to advertise to the individual which would raise the demand for the individual and, hence, lower the time available to the individual. Then at 903, the coefficient values for age, income, sax are inserted, added and the formula produces a price for that individual at 904. The coefficient values are based on the demand for the individual from the advertiser's perspective. Then, all the prices for the specific individuals matched can be added to determine the total price for the advertising spot.

A price for delivering an advertisement to target users may also be computed in a pricing scheme according to a different embodiment of the present invention. FIG. 9(b) depicts an exemplary internal functional block diagram of a different embodiment of the pricing mechanism 455 according to the present invention. The pricing mechanism 455 comprises a total delivery price estimator 910, an individual delivery price estimator 920, a demand index retriever 940, a coefficient retriever 950, and, optionally, a unit price reference table 930. The pricing mechanism 455 is configured to support a pricing scheme based on individualized pricing.

To compute the total price to deliver the advertisement 210-1 to a group of target users selected based on constraints 210-2, the total delivery price estimator 910 accesses the matching results 900 first. Based on the matching results describing the target users, the total delivery price estimator 910 may invoke, for each of the target users, the individual delivery price estimator 920 to compute the price to deliver the advertisement 210-1 to the target user. The invocation may pass on the identification of the underlying target user 915 to the individual delivery price estimator 920. After the individual delivery price estimator 920 returns a computed individual delivery price 965 for each target user back to the total delivery price estimator 910, the individual prices may then be summed to derive an overall estimated price 230-1.

To compute a price for delivering the advertisement to an underlying target user, the individual delivery price estimator 920 may consider various factors associated with, for example, the underlying target user, the importance of the target user from the content distributor's perspective, the importance of the target user from the advertiser's perspective, the delivery schedule based on which the advertisement is to be transmitted, and whether the advertisement is delivered in a derivative manner (e.g., by replacing other existing advertisement). The underlying target user may possess some features that may be of certain importance to others. Such features may also have a different degree of importance to different parties. For instance, a target user within an age group of [18, 25] may be of great importance to a content distributor that distributes content similar to MTV. Yet, such a feature (within [18, 25]) may not be important to an advertiser who advertises vitamins for people over 50 years old. Alternatively, a target user may be important to both the content distributor and the advertiser. In this case, the content distributor 220 may charge more for each unit of advertising time based on supply and demand principle.

In certain situation, the individual price for a target user is computed based on an upstream on-demand request for the underlying advertisement. In this case, the computation of the individual price charged to the advertiser may remain the same except the constraints used to estimate the individual price are received from the requesting target user. In addition, a price charged to the requesting target user (not shown) for on-demand request may also be computed. This is similar to a charge made to each pay per view in a video on demand scenario. Such price may be charged as a flat fee for each request or may also be computed based on an exemplary pricing scheme described below.

FIG. 10(a) illustrates an exemplary pricing scheme for individualized advertising, according to an embodiment of the present invention. There may be a plurality of features 1010 that are relevant in assessing the desirability of a user. Such features may include, for example, feature F₁ sex=female (1010-1), F₂ sex=male (1010-2), F₃ viewing hours/day>5 (1010-3), . . . , Fᵢ age group [18,25] (1010-4), Fⱼ age group [35,50] (1010-5), . . . , Fₘ₋₁ liking=[sports] (1010-6). The content distributor 220 may maintain, with respect to each of such features, a measure indicating the availability or supply (1020) of the target users having that feature and the availability may be evaluated in terms of time available to be exposed to advertisements. For example, the availability of users corresponding to age group [18,25] may correspond to Tᵢ (1020-i) minutes. The higher a demand is for target users with a certain feature, the lower the corresponding availability may be and the more important this feature is to the content distributor 220. Consequently, the more expensive it is for an advertiser to deliver an advertisement to users with this feature.

The exemplary pricing scheme illustrated in FIG. 10(a) is based on such supply and demand relationship. With respect to each feature, the content distributor 220 may compute an index value (1030), indicating the importance of the target users having that feature to the content distributor 220. Denote such index values by Idxᵢ, 1 <=i<=m (1030-1, 1030-2, 1030-3, . . . 1030-i, 1030-j, . . . 1030-m), each corresponding to a feature Fᵢ1<=1<=m. Such index values may be normalized within a particular range 0.0<=Idxᵢ<=1.0, for 1<=1<=m, with 1.0 corresponding to the highest level of importance and 0.0 to the lowest level of importance, and may be computed based on the corresponding availability of target users, Tᵢ, 1<=1<=m. The index value (e.g., Idxᵢ) for each feature (e.g., Fᵢ) may be inversely proportional to the corresponding availability (e.g., To). That is, the lower the availability (i.e., the more popular) of users with a certain feature (e.g., age group [18, 25]), the more important the target users with that feature are to the content distributor 220. Such index values are computed based on the content distributor's perspective.

In the mean time, from the advertiser's perspective, the advertiser 205 may also specify, e.g., in constraints, what feature(s) the target users should possess and how important these desired features are to the advertiser 205. In FIG. 10(a), the importance specified with respect to each feature is so called a coefficient (1040), denoted by Ceᵢ, 1<=1<=m, 0.0<=Ceᵢ<=1.0 with 1.0 as the highest level of importance (1040-1, 1040-2, 1040-3, . . . , 1040-i, 1040-j, . . . 1040-m). Such coefficients computed from the advertiser's perspective may not consider the supply situation at all.

The group of target users to whom the advertisement is to be delivered corresponds to users having features matching, to an acceptable degree, the desired features specified by the advertiser 205. In computing a price to deliver the advertisement to such target users, there may be various factors to be considered. For example, the importance of the target users to both the advertiser and the content distributor may be taken into account. For example, if a certain feature that is important to the advertiser 205 is also desired by many advertisers (i.e., the target user is important to the content distributor) this feature may have a higher cost. In addition, the delivery schedule may also affect the price. Delivery between 6:00 pm to 10:00 pm may cost more. The delivery time may be determined based on both the advertiser's perspective (e.g., desired delivery time) and the content distributor's perspective (e.g., broadcast schedule or limitations due to users' subscription). Similarly, the content with which the advertisement is to be delivered may also influence the price and it may also be determined based on a the supply and demand principle.

The exemplary pricing scheme illustrated in FIG. 10(a) describes a method to compute a price based on individualized prices to deliver an advertisement to corresponding individual target users according to various relevant factors. First, a desirability D(Fᵢ, Uₖ) 1050 for a particular target user Uₖ having a specific desired feature Fᵢ is estimated based on a supply and demand principle. The desirability D(Fᵢ , Uₗ ) is defined as:

D(Fᵢ,Uₖ)=Max(Ceᵢ, Idxᵢ)+Pr(Idxᵢ)×Pf(Ceᵢ, Idxᵢ)

where Max is a maximum function representing a default or base level of desirability, Pr denotes an acceleration rate and Pf denotes an acceleration schedule. The default desirability level may be computed simply as the maximum value between the importance to the content distributor 220 and the importance to the advertiser 205. For example, when the importance to the advertiser 205 is higher than that of the content distributor 220 over a particular feature, the content distributor 220 is to charge the price according to the importance to the advertiser. On the other hand, if the importance to the content distributor is higher than that to the advertiser, the content distributor 220 is going to charge the price according to the value of the target user having the underlying feature to the content distributor.

The default desirability level may be accelerated under different conditions. For example, when a target user is highly desired by both the advertiser 205 and the content distributor 220, the overall desirability should be significantly accelerated and the cost to deliver an advertisement to the target user should cost the highest. On the other hand, when neither the advertiser 205 nor the content distributor 220 finds a target user having a certain feature desirable (in this case, the default desirability is low), the acceleration should be none or near zero. For situations in between these two extreme scenarios (e.g., both the advertiser and the content distributor find a target having the underlying feature moderately desirable), the acceleration may be applied proportionally to the compound desirability.

The acceleration rate Pr is a function of Idxᵢ and the acceleration rate is determined based on the perspective of the content distributor 220. The more desirable a target user having the underlying feature is to the content distributor 220 (e.g., age group [18,25] may be very important to an MTV content distributor), the higher the acceleration rate is. The acceleration rate function Pr may be a linear or a non-linear function such as a discrete function, which provides a particular function value within each predetermined range of Idxᵢ values, e.g., for Idxᵢ in [0.0, 0.4], Pr=0, for Icxᵢ in (0.4, 0.65], Pr=1, for Idxᵢ in (0.65, 0.8], Pr=2, and for Idxᵢ in (0.8, 1.0], Pr=3. An exemplary discrete acceleration rate function is illustrated in FIG. 10(b). Such discrete function values correspond to the rates of acceleration in different situations.

The acceleration schedule Pƒis a function that may provide a predetermined acceleration amount (or premium) with respect to the relationship between the supply and demand, measured as Ceᵢ (desirability/importance from the advertiser's perspective) and Idxᵢ (desirability/importance from the content distributor's perspective). The acceleration schedule Pƒ may correspond to a continuous function of Ceᵢ and Idxᵢ and this function value may arise whenever, for example, Ceᵢ and Idxᵢ have higher values. The acceleration schedule function Pƒ may be a two dimensional continuous function with respect to variables Ceᵢ and Idxᵢ, as illustrated in FIG. 10(c), or, alternatively, it may be a one-dimensional function with its parameter being a function of Ceᵢ and Idcᵢ as shown in FIG. 10(d). In addition, the acceleration schedule function Pƒ may be a linear or non-linear function.

The amount of acceleration added on the default desirability (the max function) is, in this illustrated embodiment, determined as a product of the acceleration rate Pr and the acceleration schedule function Pƒ The effect of this product is that the acceleration may be subject to both a coarse and a fine control. The acceleration rate Pr performs coarse control and the acceleration schedule function Pƒ performs fine grained control. FIG. 10(e) shows an exemplary product of Pr and Pƒ, where the Pr controls not only the floor within each region but also amplifies the acceleration value determined according to Pƒ.

To compute a price for each individual target user, such determined desirability D(Fᵢ, Uₖ), 1 <=1 <=m, may be used to compute an overall desirability with respect to all the features of the target user. An overall desirability WD(Uₖ) 1060 of target user Uₖ may be computed across different features by, for example, a weighted sum, where the weights assigned to different features may be normalized so that they sum to one. In one embodiment, the desirability defined by the advertiser 205 may be normalized and then used as weights. This is shown in FIG. 10(a) as:

WD(Uₖ)=Ce₁×D(F₂,Uₖ)+Ce₂×D(F₂,Uₖ)+. . . +Ce₁,×D(Fₘ,Uₖ), 1≦k≦N

where Ceᵢ , 1<=1<=m, correspond to normalized desirability with respect to each of the corresponding features and defined by the advertiser 205. Each product of Ceᵢ and D(Fᵢ , Uᵢ .) may be viewed as a combined desirability of target user Uᵢ with respect to feature Fᵢ from both the content distributor's and the advertiser's perspectives. The overall desirability WD(Uₖ) 1060 of target user Uₖ (across all features) may be represented as a weighted summation with respect to different features and computed based on both the content distributor's and the advertiser's perspectives.

The overall desirability 1060 may then be used to compute an individual price P(Uₖ) 1070 for delivering an advertisement to target user Uₖ , for 1<=k <=N. An individual price 1070 may be determined, as shown in FIG. 10(a), as a product of the overall desirability of the target user WD(Uₖ ) 1060, a unit price determined as a function of different delivery schedule parameters (as discussed below), and the total amount of the exposure of the advertisement to the target user:

P(Uₖ )=WD(Uₖ)×Unit_Price(Uₖ)×ExposureAmount(Uₖ)

Finally, the total price 1080 for delivering the advertisement to all the identified target users is computed as a sum of all the individual prices for individual target users or:

$${\sum }_{k = 1}^{N} P ( {U}_{k} )$$

A unit price charged to deliver an advertisement to a target user may be determined based on different parameters related to a delivery schedule designated to the target user. A unit used in a unit price may refer to a unit in time (e.g., advertising in a television program may be measured in terms of time) or a unit in space (e.g., advertising in a magazine may be measured in terms of space occupied). As discussed with reference to FIG. 8(a), a delivery schedule associated with an individual target user may include various types of information, each of which may attribute to unit price determination. For example, delivering an advertisement with content may correspond to a higher unit price (or a lower unit price) as opposed to delivery without content. Transmitting an advertisement in a full scale multimedia form may cost more than delivering in audio form. On the other hand, delivering an advertisement in an audio form to a handheld device may cost more because of the need to perform, for example, data compression and network exchanges.

Optionally, each geographic region where the advertisement is to be delivered may correspond to a different unit price determined based on, for instance, economic reasons. Delivering an advertisement during prime time or on prime pages in a magazine may cost more. In addition, different geographic regions may have different definitions of prime time. Types of content with which the advertisement is to be delivered may also attribute to unit price difference. For example, advertising during a real time sports event broadcasting may cost more than merely re-broadcasting (or even on-demand transmission) the same sports event or advertisement during Christmas season may cost more. The distribution status of content may also affect unit price. For example, advertising during the original release of a new program may correspond to a higher unit price than advertising via the same content transmission during re-broadcasting (e.g., local TV stations may charge less to replace existing advertisement in a re-broadcast program). The unit price for replacing an existing advertisement may be higher. On the other hand, an exclusive right in an advertising period (i.e., an advertisement that is not allowed to be replaced) may also cost more. A unit price table may be predetermined that stores unit prices under different circumstances, determined based on various parameters, such as the ones discussed above.

To implement the described pricing scheme, the individual delivery price estimator 920 (FIG. 9) invokes, for each target user selected, a demand index retriever 940 to retrieve the Idx values (which may be computed by the content distributor 220 based on stored demand statistics 440-4) and a coefficient retriever 950 to retrieve the desirability with respect to different features specified by the advertiser 205. Such retrieved values are then forwarded to the individual delivery price estimator 920 that computes an overall desirability (1060) of the target user and subsequently an individual price (1070) for delivering an advertisement to the target user. As described in the exemplary individualized pricing scheme, the individual delivery price estimator 920 may access relevant information, such as a delivery schedule for the underlying target user, and retrieve a unit price, from a unit price reference table 930, based on the relevant parameters. Each estimated individual price is forwarded to the total delivery price estimator 910 where a summed total price is generated based on the individual prices.

It is also possible that the individual delivery price estimator 920 computes a price for a subgroup of target users and the total delivery price estimator 910 computes a total price by summing the prices for subgroups of target users. Each subgroup of target users may be classified based on certain criteria. For example, target users of a subgroup may all have the same feature (e.g., all in the age group of [18, 25]) or may all have the same delivery schedule (e.g., all users within a particular local broadcast region). Such a computation scheme may be employed in different situations according to application needs. For example, when a group rate is effective, the price to deliver an advertisement to a group of users that satisfy the group rate criteria may be computed for the entire group. Therefore, the individualization of prices may be performed at different scales.

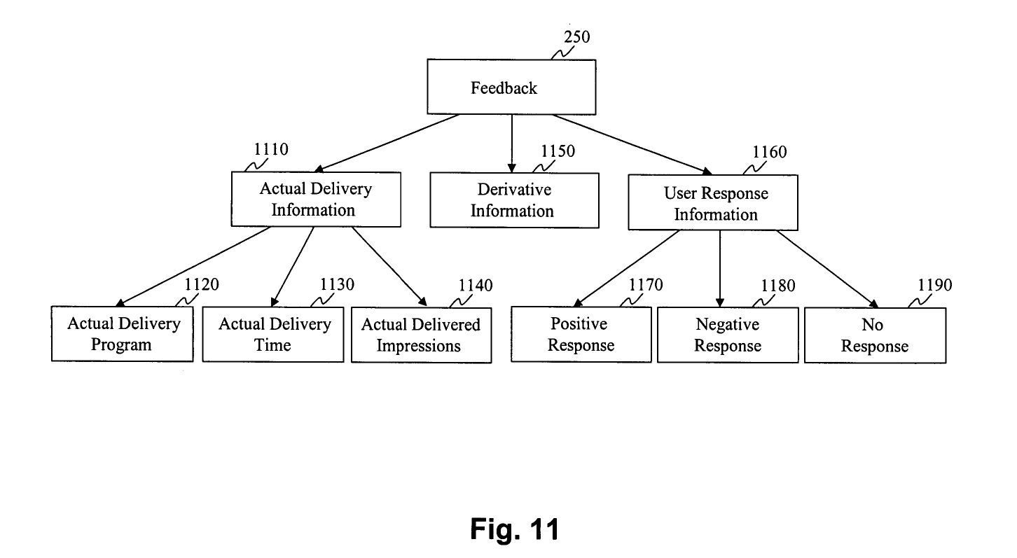

As described earlier, after the advertisement 210-1 is delivered to the target users 245, feedback 250 may be made available to different parties including the content distributor 220. FIG. 11 illustrates exemplary types of feedback according to an embodiment of the present invention. The feedback 250 may characterize the delivery of the advertisement to target users from different aspects. It may describe the actual delivery statistics 1110 which may provide detailed information in terms of the actual programs with which the advertisement is delivered 1120, the actual delivery time 1130, and actual exposure statistics 1140 related to, for example, the duration of each particular exposure and the number of repeated exposures. The actual delivery statistics may differ from the estimated delivery statistics. The program with which the advertisement is scheduled to be delivered may not be delivered (e.g., due to cancellation, power outage, or delayed earlier programs). The time originally scheduled to deliver the advertisement may be changed (e.g., due to delay of previous programs). The scheduled advertising period may be shortened or even removed when the content is transmitted to the target users. Such actual delivery statistics may be provided also in contrast with the original delivery statistics so that the receiver may readily see the discrepancies.

The feedback statistics 250 may also provide derivative information 1150 related to, for instance, whether the advertisement has been replaced or has replaced an existing advertisement in an advertising period (which may not have been originally allocated to the advertisement). In addition, the feedback 250 may also include user response information 1160 that characterizes the delivery in terms of its impact. Such information may be collected for an advertisement that solicits responses from users (e.g., an advertisement that provides an 800 number or a web site for placing an order). The collected responses may be classified into different categories such as a category of positive response 1170, of negative response 1190, and of no response 1180.

The content distributor 220 may receive the feedback 250 from different sources. For example, it may receive the feedback 250 directly from the entities through which the advertisement is relayed to the target users (e.g., regional television stations, ISPs, or regional radio stations). It may also receive or obtain feedback related to a particular distribution from a special service offered to collect data related to content /advertisement distribution or to provide statistics derived based on the collected data. The feedback 250 may be sent to the content distributor 220 or, alternatively, the content distributor 220 may access such feedback information from, for example, the service provider's web site. The feedback data 250 may be offered in different forms. For instance, it may be offered as textual data or rendered as a display to show, for example, the distribution of the delivery and for each geographical covered area, it may allow a user to click on it to invoke all the detailed statistics associated with the delivery to that region.

Different parts of the feedback 250 may be received from different sources and they may be received at different times. For example, actual delivery statistics may be collected from local relay stations. The response statistics may come from a different source. For instance, customer services (set up by a manufacturer/distributor whose product is being advertised during the delivery) that take orders for the advertised product may collect information related to responses although such customer service centers do not supply any information directly related to the delivery. In addition, different types of feedback information may be made available at different times. For example, collecting response statistics may take longer than collecting actual delivery information.

The discrepancies between the estimated delivery statistics 230-2 and the feedback information 250 may warrant an adjustment to the estimated price 230-1. The discrepancies may indicate that the intended effectiveness is not achieved due to reasons not attributed to the advertiser 205. The originally selected target users may not all receive the advertisement (e.g., due to cancellation of a program). Failure to deliver the advertisement at an originally scheduled time may also render the advertisement much less effective. For example, if an advertisement for children's toys scheduled to be delivered before 9:00 pm is not delivered until 10:15 pm (by which time most children may already be asleep) may make the advertisement not reach the intended audience. The discrepancies may also provide specific evidence that the actual impact of the advertisement exceeds an intended or expected impact (e.g., 15% positive response from the users versus an originally expected rate of 5%).

The conditions under which an adjustment may be made to the estimated price 230-1 or how the adjustment is to be made may be stipulated and agreed in the contract between the content distributor 220 and the advertiser 205. When the feedback 250 is received, according to the nature of the discrepancies, the estimated price 230-1 may be accordingly adjusted upward or downward. The price adjuster 480 may be invoked, when appropriate, to perform price adjustment. FIG. 12(a) depicts an exemplary internal functional block diagram of the price adjuster 480 according to an embodiment of the present invention. The exemplary price adjuster 480 may adjust the estimated price 230-1 according to a scheme similar to the exemplary pricing scheme illustrated in FIG. 10(a).

The price adjuster 480 comprises a total delivery price adjuster 1210, an individual delivery price adjuster 1220, a demand index retriever 1230, and a coefficient retriever 1240. Based on the matching results 900, the total delivery price adjuster 1210 invokes the individual delivery price adjuster 1220 with information related to each target user (e.g., ID) according to the matching results 900 as well as the estimated price associated with the target user. Here, each invocation may also be made with respect to a subgroup of target users. The individual delivery price adjuster 1220 may first determine whether there is a discrepancy between the delivery schedule 745 and the actual delivery status (contained in the feedback 250) with respect to the underlying target user. If there is no discrepancy (the advertisement is delivered according to schedule), no adjustment may be made or the output adjusted price for the target user is the same as the estimated price for the user.

If there is a discrepancy between the delivery schedule 745 and the actual delivery, the individual delivery price adjuster 1220 may then calculate the adjustment and apply the adjustment to the estimated price to produce an adjusted price 1245 for the target user. The adjusted individual price 1245 is forwarded to the total delivery price adjuster 1210 and used in calculating the actual price (or adjusted price) 260-1.

There may be different ways to calculate the individual adjusted price. An actual delivery price may be computed directly based on actual delivery information contained in the feedback 250. In this case, the estimated price for an individual user is replaced by the actual price 1245 for the same individual. The computation of an actual price may be carried out according to the pricing scheme described in FIG. 10(a). In this case, the individual delivery price adjuster 1220 may first determine whether a target user who is scheduled for advertisement delivery (determined according to the matching result 745) actually receives the advertisement (e.g., the program may be canceled due to delay or power outage). If not, the actual price may be simply set to zero. If the actual delivery is exactly the same as the scheduled delivery, the actual price may be simply set equal to the estimated price.

When the actual delivery does not follow exactly as the scheduled delivery (based on which the estimated price is computed), a non-trivial adjustment may be carried out. There may be different ways to perform such an adjustment. One way is to simply compute an actual price based on actual delivery information. In this case, the individual delivery price adjuster 1220 may calculate the actual price in a way similar to how the individual delivery price estimator 920 computes an estimated price, except here actual delivery information is used. To calculate an actual price, the individual delivery price adjuster 1220 invokes the demand index retriever 1230, to retrieve Idxᵢ, 1<=i<=m, and the coefficient retriever 1240, to retrieve Ceᵢ , 1<=i<=m. The actual price is then computed using such retrieved measures based on an actual unit price, retrieved from the unit price reference table 825 using information related to actual delivery status, including an actual delivery time or actual program with which the advertisement is transmitted to the target user. Other parameters used in determining an actual price may relate to the actual exposure of the advertisement to the target user such as a length, in time, for each exposure and the number of repetitions during the actual delivery.

Alternatively, the estimated price may also be adjusted based on the degree of discrepancy between the delivery schedule and the actual delivery data. Such discrepancy may be positive or negative. A positive discrepancy may correspond to a scenario in which the actual delivery status is better than estimated. For example, an actual delivery may be better than a scheduled delivery due to, for example, a delay of an earlier program so that an advertisement originally scheduled to be delivered at a non-prime time may actually be delivered at prime time (with advertiser's permission, specified in, for example, constraints) or that the actual response rate exceeds the originally estimated response rate (e.g., stipulated in the advertising agreement). In this case, the estimated price may be adjusted upward, if the contractual parties so agreed.

A negative discrepancy may correspond to a scenario in which the actual delivery status is worse than estimated. This may be assessed in terms of, for instance, the coverage (e.g., fewer target users are actually covered), the delivery time (e.g., the actual delivery time is no longer prime time as scheduled), the length of exposure (e.g., shortened period in single exposures or fewer repetition), or the response rate (e.g., lower than estimated). The level of degradation may be evaluated according to application needs. For example, if the coverage is more important than exposure amount, then an actual coverage below the estimated coverage may be considered much more damaging than having exposure amount actually prolonged.

Depending on the degree of discrepancy, the adjustment may be applied differently. For instance, there may be several discrete degrees of discrepancy as illustrated in FIG. 12(b), where the x-axis represents the degree of discrepancy, measured as a degree of match between the actual delivery status and the estimated statistics, and the y-axis represents the adjustments made to the estimated price, measured in terms of a percentage with respect to the estimated price. Between two adjacent discrete degrees of discrepancy, a particular adjustment scale function may apply to control the amount of adjustment. For example, between discrepancy range [−0.25, 0.0], an adjustment scale function F(d) applies, where d represents the value of the discrepancy; in the discrepancy range [−0.65, −0.25], a different adjustment scale function G(d) applies; in the discrepancy range [−1.0, −0.65], an adjustment scale function H(d) applies which, in this example, has a much sharper adjustment to a larger discrepancy in a negative direction.

These adjustment scale functions may be designed appropriately to reflect business decisions and they may be dynamically reconfigured when the economic situation or policy changes. For different ranges of discrepancies, different adjustment scale functions may be applied to capture either price acceleration (upward adjustment) versus deceleration (downward adjustment) or differences in adjustment rates. In the illustrated embodiment shown in FIG. 12(b), the adjustment scale functions used in negative discrepancy situations (on the left of the y-axis) control downward adjustments (deceleration) and the adjustment scale functions used in positive discrepancy situations (on the right of the y-axis) control upward adjustments (acceleration).

Each adjustment scale function may be designed to provide different adjustment rates (corresponding to different slopes of the underlying functions). For example, when a positive discrepancy is below a certain range (e.g., below 25%), the estimated price may not be adjusted (adjustment rate is zero or the slope of the adjustment scale function for that range is zero). When a positive discrepancy exceeds 25%, the estimated price is adjusted upward according to a rate represented by the slope of function J(d). When it exceeds 50% (much enhanced delivery), the adjustment pace may be bigger controlled by a higher rate represented by the slope of function K(d).

Similarly, when a negative discrepancy exists, the estimated price is adjusted downward. The amount or the rate of downward adjustment may depend on the degree of negative discrepancy. As shown in the example adjustment scale functions, a downward adjustment rate within the discrepancy range [−0.25, 0.0] may be smaller than a downward adjustment rate for the discrepancy range [−1.0, −0.65]. The rate of adjustment within a particular range may remain constant as in the case of linear adjustment scale functions (as shown in FIG. 12(b)) or it may be designed to also change with the degree of discrepancy by deploying a non-linear adjustment scale function (not shown in FIG. 12(b)). The price adjustment may also be performed with respect to subgroups of target users (as opposed to individuals).

Other price adjustment schemes may also be implemented. For example, for every second shortened in exposure, there may be an agreed deduction in price. For every one half of an hour of deviation from the contracted delivery time, there is an agreed change (either positive or negative, depending on the outcome of the deviation) in price. For every single positive response from target users, there may be an agreed increase in price. The price adjuster 480 may compute a price adjustment consistent with an agreement between the advertiser 205 and the content distributor 220. It is also possible that with different advertisers, a different method to adjust the price is preferred. In this case, the price adjuster 480 may be configured to be able to deploy different individualized adjustment schemes (not shown) with respect to different advertisers.

### Advertiser

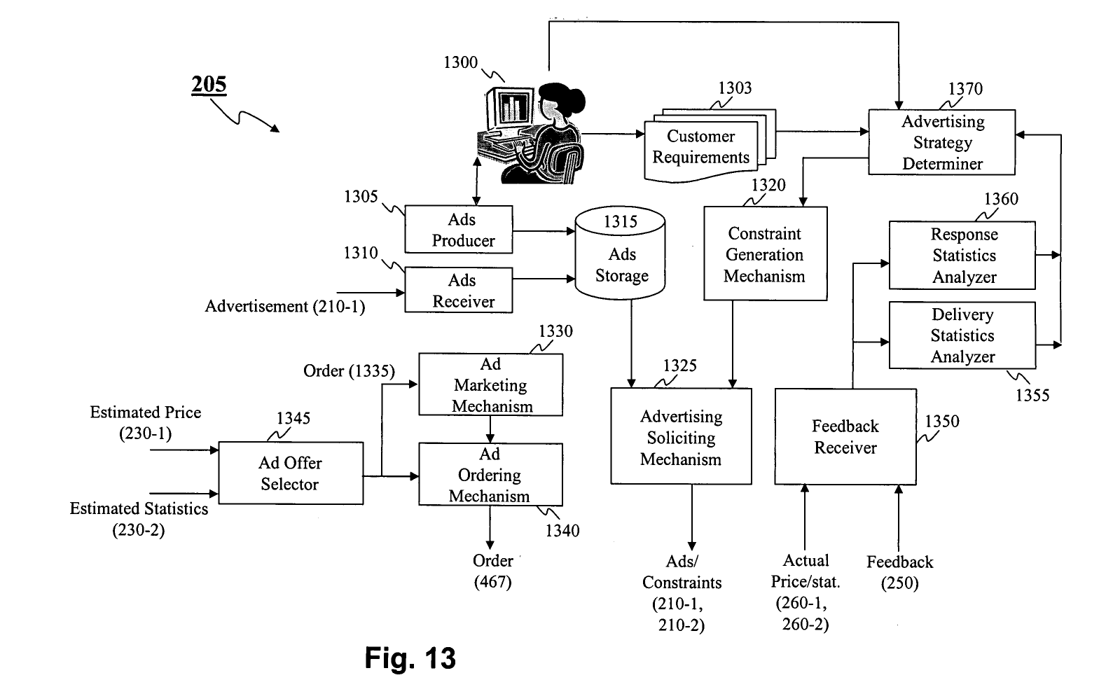

FIG. 13 depicts an exemplary internal functional block diagram of the advertiser 205 according to an embodiment of the present invention. The advertiser 205 comprises a constraint generation mechanism 1320, an advertising period solicitation mechanism 1325, an advertising offer selector 1345, an advertisement ordering mechanism 1340, and a feedback receiver 1350. The constraint generation mechanism 1320 is configured to produce one or more constraints associated with delivering an advertisement to desired target users. Such constraints may be generated based on some advertising strategies, provided, optionally, by an advertising strategy determiner 1370. Such generated constraints are forwarded to the advertising soliciting mechanism 1325 that is configured to solicit offers for delivering an advertisement within the specified constraints. Such solicitations may be sent to one or more content distributors (220) with an advertisement to be delivered (210-1) and the constraints (210-2) attached to the intended delivery.

Upon receiving the solicitation for an offer to deliver the advertisement, one or more content distributors may respond and subsequently send their offers to the advertiser 205. When the advertising offer selector 1345 receives such offers (the estimated price 210-1 and the accompanying estimated statistics 210-2), it may choose, if more than one offer is received, a best offer, determined by, for example, assessing the cost effectiveness of the offer in light of the discrepancies between the estimated statistics (accompanying the offer) with the desired constraints. When a best offer is selected, the advertising offer selector 1345 may act on it by, for example, forwarding the best offer to the advertising ordering mechanism 1340. The advertising ordering mechanism 1340 may then place an order and conduct further communications with the content distributor who made the offer in terms of other detailed contractual terms regarding the advertising period.

Optionally, the advertising offer selector 1345 may also forward the best offer to an advertising marketing mechanism 1330 which may be configured to further forward the best offer to other potential advertisers (or buyers) to solicit acceptance in purchasing the advertising period. This may occur when the advertiser 205 is an advertising agency. In this case, the advertising marketing mechanism 1330 may transmit its own offer/solicitation 1332 (which may have terms different from the best offer it received) to solicit its own buyers. An order 1335, as a response to this secondary solicitation from a secondary buyer, may be subsequently received and forwarded from the advertising marketing mechanism 1330 to the advertising ordering mechanism 1340 so that an order (467) may be placed on behalf of the secondary buyer to the original offerer of the advertising period.

Alternatively, the advertiser 205 may receive an offer for delivering an advertisement via an advertising period without ever communicating its desired constraints to the content distributors from whom solicitations of acceptance are received. That is, it may receive solicitation(s) for acceptance of advertising periods characterized by various estimated statistics (e.g., how many people to be reached, at what time, with what program, and the details related to the length, in time, in exposing the advertising period to the audience reached). In this case, the advertising offer selector 1345, upon receiving the offer, may determine a best offer based on different measures, such as unit price per target user or unit price per target user given the delivery time. Different schemes may be implemented and choices of implementation strategy may depend on application needs. A system may be implemented capable of carrying out different schemes, activation of which may then be determined dynamically according to the run time situation. A system may also be implemented as re-configurable so that in different application settings, some selected mode(s) of operation may be configured as active.

The advertiser 205 may also include an advertisement storage 1315, configured to store advertisements electronically. The advertiser 205 may also include an advertisement producer 1305 that generates advertisement(s) and stores such generated information in the advertisement storage 1315. For instance, the advertiser 205 may correspond to an advertising agency that provides advertisement services to its customers including generating advertisement content based on a customer's business/product. The advertiser 205 may also include an advertisement receiver 1310 configured to receive an advertisement 210-1 from another party (e.g., a customer) that wants the advertiser 205 to identify appropriate channels and advertising strategy for an advertisement created by the other party.

The advertiser 205 may further include a feedback receiver 1350 configured to receive feedback information associated with an actual delivery of an advertisement and possibly an adjusted price (260-1 and 260-2) from a corresponding content distributor. The advertiser 205 may receive the feedback information from more than one source. It may receive the feedback from the content distributor that delivered the advertisement. It may also receive the feedback from a special service offered to collect data related to content/advertisement distribution or to provide statistics derived based on the collected data. It is also feasible for the advertiser 205 to obtain the feedback through a forum where all subscribers to a data collection service may retrieve data related to their content delivery. For example, the feedback information may be retrieved or accessed from a service provider's web site.

The feedback data 250 may be made available in different forms. For instance, it may be offered as textual data or rendered as a display to show, for example, the distribution of the delivery and for each geographical covered area (e.g., a bar chart to show a quantized distribution with respect to each age group). For a geographic map display, the service provider may also allow a user to click on a particular geographical location to invoke the display of detailed statistics associated with the delivery to that region.

Different parts of the feedback may be received from different sources and at different times. For example, actual delivery statistics and an adjusted price may be received from the content distributor that made the delivery. The response statistics may come from related call centers (set up by a manufacturer/distributor whose product is being advertised during the delivery) that take orders for the advertised product.

The advertiser 205 may further analyze the received feedback information. A delivery statistics analyzer 1355 may perform analysis on the actual delivery feedback information and a response statistics analyzer 1360 may perform analysis on received response information. The analysis results may be forwarded to an advertising strategy determiner 1370, which may then rely on data from different sources (e.g., the feedback analysis results) to dynamically adapt advertising strategy to optimize the effectiveness for future deliveries. The advertising strategy determiner 1370 may also derive advertising strategies based on known customer requirements 1303 recorded by, for example, an advertising agent 1300, based on customers' requests. The advertising agent 1300 may also provide input directly to the advertising strategy determiner 1370.

### Process Flows

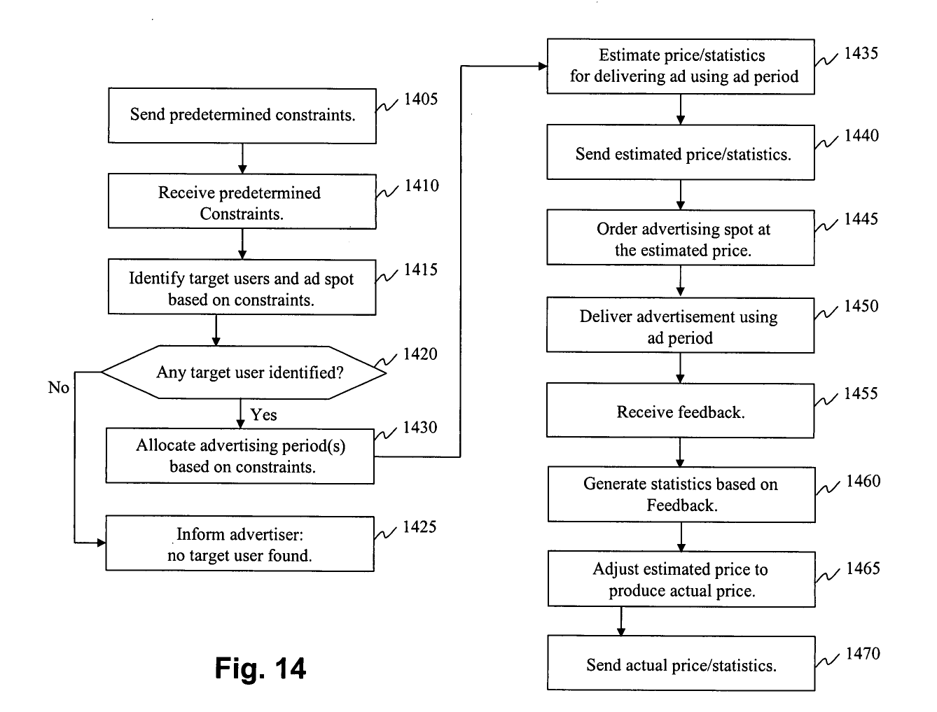

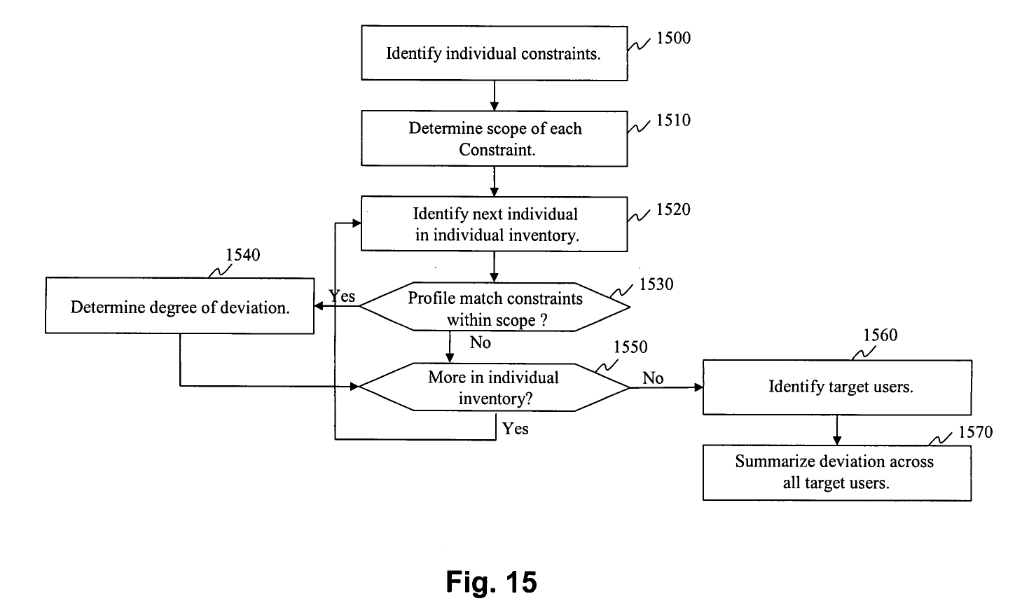

FIGS. 14-21 describe process flows involved in achieving statistics based individualized advertising. FIG. 14 is a flowchart of an exemplary overall process, in which an advertisement is ordered and delivered in an individualized advertising scheme according to embodiments of the present invention. One or more constraints are first sent, at 1405, to a content distributor via a network. The constraints are related to the delivery of an advertisement to one or more target users who have certain features that match relevant constraints in a manner consistent with the constraints. After receiving the constraints, at 1410, the content distributor identifies, at 1415, target users based on the constraints. Details related to the identification of target users based on constraints are described in FIG. 15. When no target user is found who satisfies the constraints, determined at 1420, the content distributor informs, at 1425, the advertiser from whom the constraints are received.

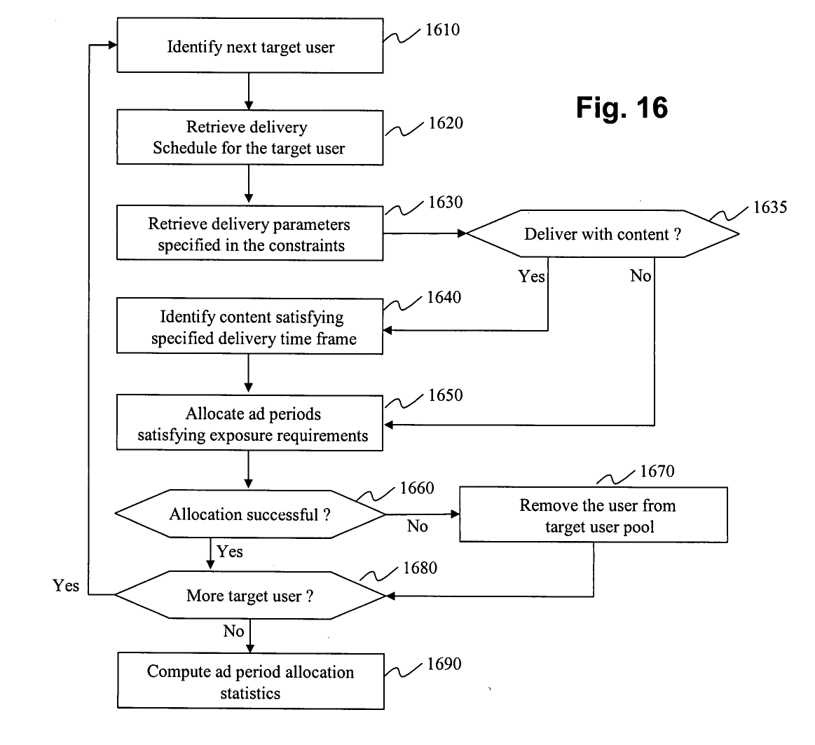

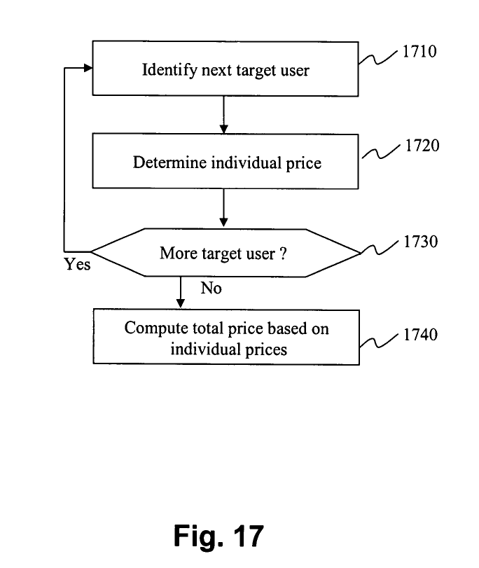

If target users meeting the constraints are found, the content distributor allocates, at 1430, an advertising period based on the delivery parameters provided in the constraints. The advertising period may be allocated with respect to content that is scheduled to be transmitted to each of the target users. Details related to allocation of advertising periods are discussed with reference to FIG. 16. Based on the allocated advertising period, the content distributor determines, at 1435, an estimated price for delivering the advertisement to the target users. The estimated price may be computed based on various parameters such as coverage and individualized delivery schedule, determined adaptively in a manner that best matches the delivery parameters specified in the constraints. Details related to determining the estimated price are discussed with reference to FIG. 17. Such estimated price is then sent as an offer, at 1440, together with estimated statistics, characterizing a scheduled delivery of the advertisement, from the content distributor to the advertiser.

When an advertiser (which does not have to be the advertiser who provides the constraints) receives the offer and decides to accept the offer, the advertiser places an order, at 1445, to deliver the advertisement using the advertising period to described target users at the offered price. Upon receiving the order, the content distributor delivers, at 1450, the advertisement using the advertising period. The advertisement may or may not be transmitted with certain content. When the advertisement is to be delivered alone without content, the advertising period may correspond to length of time allocated to the advertisement. The advertisement may also be delivered with content scheduled to be transmitted to each of the target users according to their individual requests (e.g., according to individuals' subscriptions or dynamic demands such as video on demand). When transmitted with content, the advertisement may be transmitted as a separate entity independent of content (e.g., sent as a pop-up advertisement which may be played back either synchronously or asynchronously with respect to content playback). Alternatively, the advertisement may also be transmitted as an integral part of the content (e.g., a 10 second advertising period is inserted into a movie with an interval of every 15 minutes) and played back in a synchronous manner with the content. Furthermore, the advertisement may also be sent to the target users without other content.

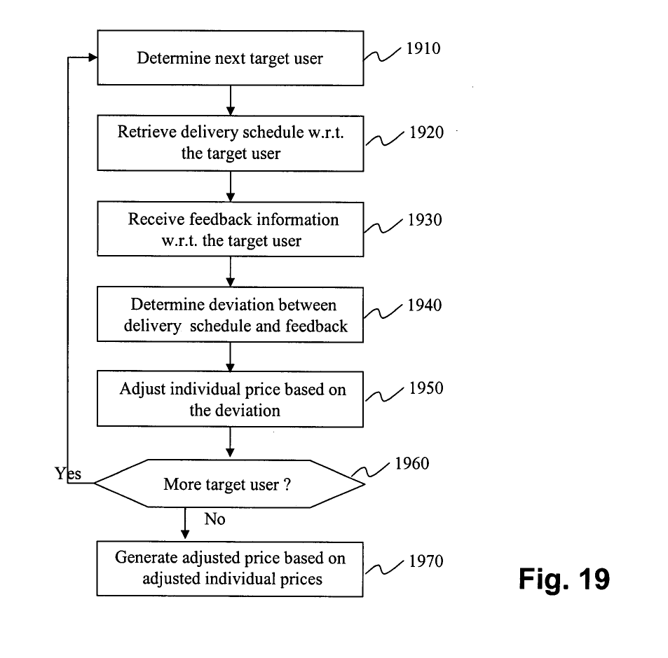

After the delivery, the content distributor 220 may receive or obtain, at 1455, feedback information characterizing the actual delivery. Alternatively, an advertiser (e.g., the advertiser who provides the constraints or the advertiser who places the order) may also receive or obtain such feedback information either forwarded from the content distributor or directly from a third party (e.g., a service provider or a local exchange). The received feedback information may then be analyzed, at 1460, for different purposes. The content distributor may then accordingly adjust, at 1465, the estimated price according to statistics related to the actual delivery. Discussion related to adjusting the estimated price is presented with reference to FIG. 19. Such adjusted price may be sent, at 1470, to the advertiser with statistics characterizing the actual delivery.

FIG. 15 is a flowchart of an exemplary process, in which desired target users are identified based on constraints, according to an embodiment of the present invention. Individual constraints contained in the constraints may be first identified, at 1500, and the scope of such identified individual constraints may also be determined at 1510. For instance, a specific constraint may be related to age (individual constraint) and its specific scope may be [18,25]. Such processing may be performed by the constraint pre-processor 570 (FIG. 5). Some of such identified constraints and scopes may be used to select target users and some may be used in determining individual delivery schedules with respect to each individual target user.

Relevant constraints and corresponding scopes are then used in identifying target users from the customer information storage (where information related to individual customer inventory is stored). For each customer/user, identified at 1520, the profile of the user is compared with the relevant constraints to see whether the profile matches, determined at 1530, the required scopes of the underlying constraints. The degree of match required may be configured so that an inexact match is permitted and such required degree of match may also be dynamically reconfigured when needed. When a match is found, the degree of deviation from the specified scope of the constraint may be determined at 1540, which may later be used in characterizing the overall match or in determining an estimated price. The process of selecting target users continues until, determined at 1550, all the individual profiles (or alternatively a specified group of profiles) are compared with the relevant constraints. Target users are then selected, at 1560, based on all the matches and overall statistics with respect to such selected target users are then computed at 1570.

FIG. 16 is a flowchart of an exemplary process, in which advertising periods are allocated in an individualized manner, according to an embodiment of the present invention. For each target user, identified at 1610, a delivery schedule made according to information specific to the target user (e.g., subscription, on-demand request, or others) is retrieved at 1620. Such an individualized delivery schedule may indicate the time frame within which an advertisement can be delivered to a target user. The schedule may be derived based on, for example, user's profile (e.g., indicating a preferred time frame for advertisement delivery), subscription information (e.g., for tennis product advertisement), or statistics indicating a peak time frame during which the user has responded an advertisement. The delivery schedule may also indicate the content to be transmitted to the target user within a period time (e.g., within the time frame by which the advertisement is to be delivered). Depending on whether the advertisement is to be delivered with or without content, the advertising period allocation may be carried out differently. For example, if the advertisement is to be delivered without content, the allocation is to identify a period during which no content is scheduled to be delivered and which satisfies the duration requirement (e.g., enough, time-wise or space-wise, to fit the advertisement). If content is involved, then the advertising period allocation may be carried out based on a plurality of factors.

To allocate the advertising periods, the delivery parameters specified by the advertiser in the constraints are retrieved at 1630 and used in advertising period allocation (e.g., constraints related to delivery time frame and required exposure amount in time). If the advertisement is to be delivered with content, determined at 1635, suitable content within which the advertising periods may be allocated can be identified at 1640. The advertising periods satisfying the specified delivery parameters, either within such identified content or without such content, are allocated at 1650. If the allocation is not successful (e.g., not possible because no content during a specified time frame is long enough to satisfy the required exposure amount), determined at 1660, the target user may be removed, at 1670, from the selected target user pool (and corresponding statistics characterizing the coverage may be accordingly revised). The individualized allocation process continues until, determined at 1680, allocation for every target user has been performed. Statistics related to allocation may then be computed at 1690.

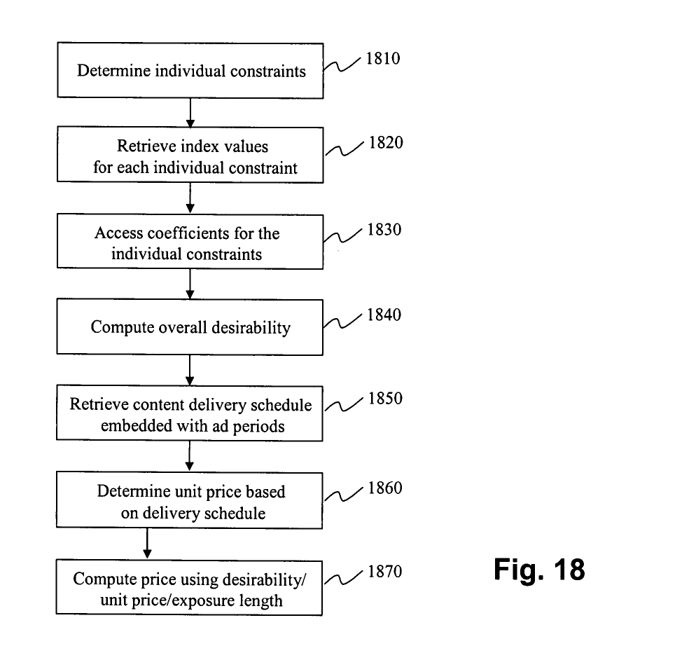

FIG. 17 is a flowchart of an exemplary process, in which a price for delivering an advertisement to desired target users is estimated according to an embodiment of the present invention. For each target user, identified at 1710, an individualized price is determined at 1720. An exemplary pricing scheme to compute an individualized price is described with reference to FIG. 18 below. When individual prices for all target users are estimated, determined at 1730, a total price for delivering the advertisement to the selected target users is computed at 1740.

FIG. 18 is a flowchart of an exemplary process, in which a price for delivering an advertisement to a selected individual target user is determined according to an embodiment of the present invention. For each selected target user, identified at 1810, an index value and a coefficient value with respect to the same feature of the target user are retrieved, at 1820 and 1830, respectively. As discussed earlier, the retrieved index value may reflect the desirability of the target user from the content distributor's perspective and the coefficient (accessed from the constraint) may reflect the desirability of the target user from the advertiser's perspective. Based on the desirability of the target user from both content distributor's and the advertiser's perspectives, an overall desirability WD(Uₖ ) (or a compound desirability) for the target user may be computed, at 1840, according to the exemplary formula illustrated in FIG. 10(a).

To determine a unit price, a delivery schedule for content with which the advertisement is to be delivered is retrieved at 1850. A unit price is then determined, at 1860, according to the delivery schedule for the target user. Such a unit price is then used, together with the computed overall desirability and the total exposure amount of the advertisement, to compute, at 1870, an individual price for delivering the advertisement to the target user.

FIG. 19 is a flowchart of an exemplary process, in which an estimated price for delivering an advertisement to a desired group of target users is adjusted based on feedback statistics, according to an embodiment of the present invention. As discussed earlier, there may be different embodiments by which a price adjustment may be made. The flowchart in FIG. 19 illustrates one of such possible embodiments, in which an estimated overall price is adjusted by adjusting the price for each of the target users based on statistics characterizing the actual delivery of an advertisement.

To adjust an estimated price for delivering an advertisement to a group of target users, for each target user, identified at 1910, the original delivery schedule for the target user is first retrieved at 1920. Feedback information characterizing the actual delivery status is also retrieved (or received) at 1930. A discrepancy or deviation between the original delivery schedule and the information related to the actual delivery status is determined at 1940. Based on such determined discrepancy, an adjustment to the estimated individual price for the target user is made at 1950, if there is a discrepancy. As discussed earlier, an adjustment to an individual estimated price may be made using different methods. For instance, an actual price may be computed based on the actual delivery information and used to replace the original estimated individual price (as illustrated in FIG. 12(a)). Alternatively, the discrepancy itself may be used to determine an upward or a downward adjustment based on some pre-configured function (as illustrated in FIG. 12(b)). It should be appreciated that the demonstrated embodiments do not limit the invention. They merely provide exemplary methods. Other approaches to compute an actual individual delivery price can also be implemented. For example, instead of adjusting prices for each single target user, an adjustment may also be made by adjusting prices for different subgroups of target users. When all the originally estimated individual prices are adjusted, determined at 1960, an overall actual price (or adjusted price) may then be generated, at 1970, based on individual adjusted prices.

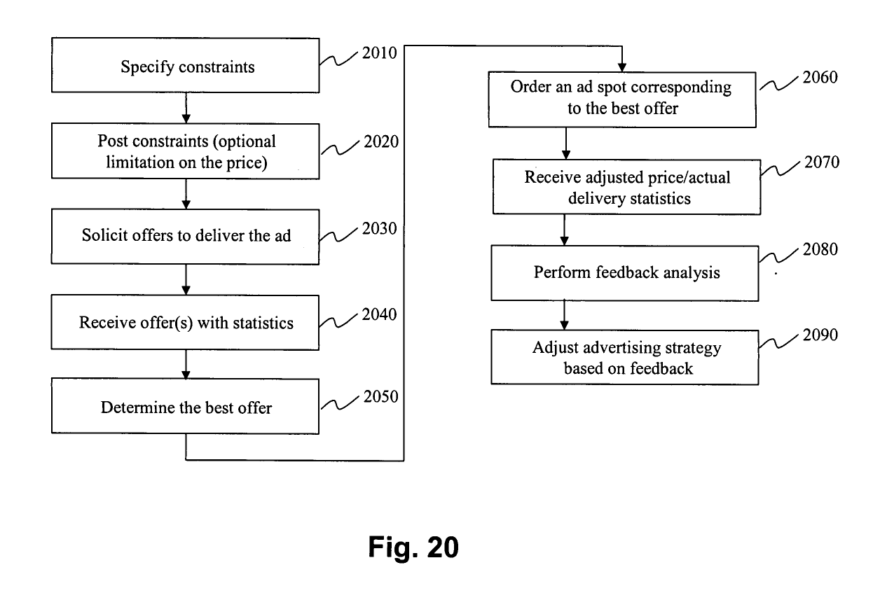

FIG. 20 is a flowchart of an exemplary process, in which an advertiser conducts statistics-based individualized advertising according to embodiments of the present invention. The advertiser may first specify, at 2010, a set of constraints related to delivering an advertisement to users satisfying the constraints. Such constraints may include both the characteristics of target users and the delivery parameters such as delivery time frame, single exposure amount, repetition rate, or receiving devices. The advertiser may then post, at 1920, the constraints to one or more content distributors to solicit offers at 2030. The advertiser may also optionally specify, in addition to the constraints, a limitation regarding the highest price they are willing to pay for delivering the advertisement.

When the advertiser receives, at 2040, offer(s) with accompanying statistics characterizing proposed delivery schedules for delivering the advertisement to a group of target users, both determined based on the posted constraints, the advertiser may determine, when more than one offer is received, a best offer at 2050. An acceptance of the best offer may be placed as an order, at 2060, to deliver the advertisement using allocated advertising periods embedded in individual pieces of content to be transmitted to target users. Here, the advertiser who accepts the offer from a particular content distributor may not be the same advertiser as the one who provided the constraints.

After the order to deliver the advertisement is carried out, the advertiser (either the one who provided the constraints or the one who places the order or both) may receive, at 2070, an actual price, adjusted based on statistics characterizing the actual delivery status. The statistics may be received from the content distributor who carries out the delivery, or retrieved from a third party service provider. Feedback analysis may be performed, at 2080, based on such received statistics and advertising strategy may be adaptively adjusted, at 2090, based on the outcome of the feedback analysis.

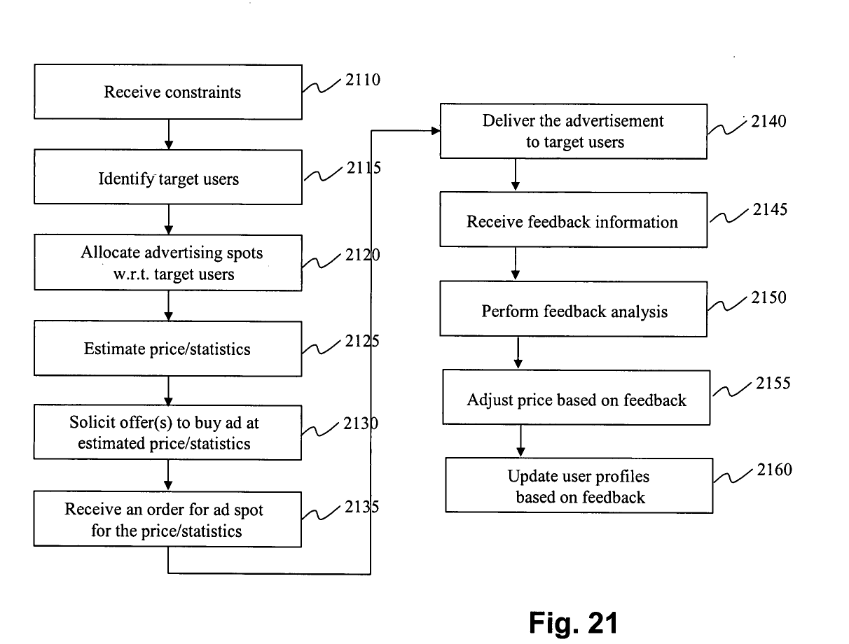

FIG. 21 is a flowchart of an exemplary process, in which a content distributor performs statistics-based individualized advertising according to embodiments of the present invention. First, the content distributor receives, at 2110, constraints specified to limit the conditions under which an advertisement is to be delivered. Such constraints may be received from an advertiser who solicits a bid from the content distributor. The content distributor may also specify the constraints when, for example, the content distributor is also engaged in advertising. Based on the constraints characterizing desired users, a set of target users are identified at 2115. To deliver the advertisement to the target users, the content distributor may allocate, at 2120, advertising periods embedded in content to be transmitted to individual target users. For different target users, the advertising periods may be allocated in different content, determined according to individual information associated with the target user. In addition, the allocation is made based on delivery parameters specified in the constraints.

An estimated price for delivering the advertisement using allocated advertising periods to target users may then be estimated at 2125. The computation of the estimated price is described earlier with reference to FIGS. 10(a)-10(e). With the computed price and the statistics based on which the price is estimated, the content distributor may then solicit, at 2130, an acceptance of its offer to deliver the advertisement at the estimated price and in a manner characterized by statistics characterizing various aspects related to the proposed delivery. The content distributor may send the offer to the advertiser who provided the constraints or to other third party advertisers to solicit a buyer. The offer may be sent with other contractual terms such as, under what condition(s) the estimated price may be adjusted in a specified manner.

When the content distributor receives, at 2135, an order or an acceptance to deliver the advertisement at the offered price, the content distributor transmits, at 2140, the advertisement to the target users. The delivery may be carried out during transmission of the content. After the actual delivery, the content distributor may receive (or obtain), at 2145, feedback information characterizing the status of the actual delivery of the advertisement. Feedback analysis may be performed, at 2150, before the content distributor adjusts the estimated price at 2155. The feedback information may also be utilized to determine how to update, at 2160, the profiles of the target users (e.g., update data in the profile related to their response to the type of the delivered advertisement).

The present invention can be implemented with any number of general processors, dedicated processors, or specially designed circuits. Each box shown in the figures can be a dedicated circuit, a separate processor performing the function, or software performing the function on a processor that performs a plurality of the indicated functions. Each block in the flow diagram may be performed through software or a dedicated circuit. Although the present invention has been described in detail with respect to certain embodiments and examples, variances and modifications exist which are within the scope of the present invention as defined in the following claims.

1. A method for advertising, comprising:
receiving, by a content distributor over a network, one or more constraints related to performance of an advertisement;
determining an estimated price for the advertisement based on estimated statistics computed with respect to one or more target users selected based on the one or more constraints; and
sending, over the network, the estimated price and the estimated statistics, wherein the one or more constraints define
desired characteristics of the one or more target users to whom the advertisement is to be delivered, and
delivery parameters based on which the advertisement is delivered to the one or more target users.

2. The method according to claim 1, wherein the advertisement is delivered using an advertising period.

3. The method according to claim 2, wherein the advertising period is allocated based on the delivery parameters.

4. The method according to claim 3, wherein the advertising period is allocated in content to be delivered to a target user.

5. The method according to claim 1, wherein the content distributor is one of:
a content producer who distributes its own produced content;
a secondary distributor who receives content from another source and distributes the content;
a content portal who provides a gateway to content; and
a combination thereof.

6. The method according to claim 1, wherein the one or more constraints are received from one of:
an advertiser including one of:
an advertising agency,
a business entity,
an organization, and
an individual; and
a user of the content distributor.

7. The method according to claim 1, wherein
the advertising period is embedded in the content to be transmitted to each of the one or more target users; and
the advertisement is delivered to each of the one or more target users during transmission of the content, whether before, after or by interrupting the content, or by placing the advertised product or service in the content itself and by inserting the advertisement into the advertising period.

8. The method according to claim 1, wherein the one or more constraints include at least one of a demographic constraint, a program constraint, a time constraint, a geographic constraint, an institutional constraint, a derivative constraint, and a receiving device constraint.

9. The method according to claim 8, wherein the one or more constraints includes the demographic constraint based on at least one of gender, income, age, and the number of targeted users at a reception location.

10. The method according to claim 8, wherein the one or more constraints includes the time constraint specifying delivery parameters, including at least one of a time frame within which the order for the advertising period is to be completed, number of programs with which the advertisement is to be delivered, a desired delivery time, a desired duration of each single exposure, and a desired repetition rate with respect to a unit time.

11. The method according to claim 8, wherein the one or more constraints includes the program constraint specifying desired content and/or advertisement to be transmitted.

12. The method according to claim 8, wherein the one or more constraints includes the derivative constraint specifying whether an advertising period can be allocated in replacement of an existing advertisement and/or whether the advertisement to be inserted in the advertising period can be replaced by another advertisement.

13. The method according to claim 1, wherein said determining comprises:
searching information related to a plurality of individuals, each having a profile;
identifying the one or more target users by comparing the one or more constraints to the profiles of the plurality of individuals and identifying the target users whose profiles match the one or more constraints;
computing the estimated statistics based on the identified one or more target users and the advertising period allocated in content to be transmitted to each of the target users; and
calculating, based on the estimated statistics, an estimated price for delivering the advertisement to the identified one or more target users using the allocated advertising period during transmission of content.

14. The method according to claim 13, further comprising allocating an advertising period based on the delivery parameters contained in the one or more constraints.

15. The method according to claim 14, wherein the advertising period is allocated in content, when the advertisement is to be delivered with the content.

16. The method according to claim 13, wherein the estimated statistics include at least one of:
number of the one or more target users;
number of target users at a reception location;
a measure characterizing a degree of match between each target user's profile and the one or more constraints;
a measure characterizing a degree of match between the delivery schedule by which the advertisement is to be delivered to each of the one or more target users and the delivery parameters.

17. The method according to claim 16, wherein a delivery schedule for a target user includes at least one of:
a destination for the delivery;
content to be delivered to the target user;
a delivery time by which the content is to be delivered to the target user;
an amount of each single exposure;
a repetition rate of exposure in the content; and
a derivative status indicating whether the advertisement is performed by replacing an existing advertisement.

18. The method according to claim 13, wherein said calculating the estimated price comprises:
determining an overall desirability for each of the target users from one or both of the advertiser's perspective and the content distributor's perspective;
calculating an individual price for delivering the advertisement to each of the one or more target users based on the overall desirability of the target user; and
computing the estimated price for delivering the advertisement to the one or more target users based on the calculated individual prices.

19. The method according to claim 18, wherein said determining an overall desirability of a target user comprises:
accessing an index value associated with the target user with respect to each of the constraints, wherein the index value indicates the desirability of the target user from the content distributor's perspective;
retrieving a coefficient value, specified by the advertiser, with respect to each of the constraints, wherein the coefficient value indicates the desirability of the constraint from the advertiser's perspective; and
computing the overall desirability for the target user based on the index value and the coefficient value associated with the target user with respect to each of the constraints.

20. The method according to claim 18, wherein said calculating an individual price for delivering the advertisement to a target user comprises:
determining a unit price for delivering the advertisement to each of the target users based on a delivery schedule for the target user;
determining a total exposure amount by which the advertisement is to be exposed to the target user; and
computing the individual price based on the overall desirability of the target user, the unit price, and the total exposure amount.

21. The method according to claim 1, further comprising delivering, after receiving an order for performing the advertisement over a network, the advertisement to the one or more target users.

22. The method according to claim 21, wherein the advertisement is delivered during transmission of content using an advertising period allocated in the content to each of the target users.

23. The method according to claim 21, wherein the advertisement is delivered to each of the target users in a media form determined based on a specific device on which the target user is to receive the advertisement and the media form includes at least one of multimedia, video, audio, text, paper, and any combination thereof.

24. The method according to claim 21, further comprising receiving feedback statistics after the delivering of the advertisement.

25. The method according to claim 24, wherein the feedback statistics include at least one of delivery statistics, derivative statistics, and user response statistics.

26. The method according to claim 25, wherein the delivery statistics include at least one of actual content with which the advertisement is delivered, actual delivery time, and actual amount of exposure of the advertisement.

27. The method according to claim 24, further comprising generating an actual price for delivering the advertisement to the one or more target users or target reception locations by adjusting the estimated price based on the received feedback statistics.

28. The method according to claim 27, further comprising sending, from the content distributor, the actual price and the feedback statistics to an advertiser who ordered the delivery.

29. A method for an advertiser, comprising:
receiving, over a network, an estimated price and estimated statistics related to deliver an advertisement to one or more target users or target reception locations;
placing an order, based on the estimated price and the estimated statistics, for delivering the advertisement to the one or more target users or reception locations, wherein the one or more target users or reception locations are determined according to one or more constraints which define:
desired characteristics of the one or more target users or reception locations to whom the advertisement is to be delivered, and
delivery parameters based on which the advertisement is to be delivered to each of the one or more target users or reception locations.

30. The method according to claim 29, wherein the advertisement is delivered using an advertising period.

31. The method according to claim 30, wherein the advertising period is allocated based on the delivery parameters.

32. The method according to claim 31, wherein the advertising period is allocated in content to be delivered to a target user.

33. The method according to claim 29, wherein
the estimated price and the estimated statistics are received from one of an advertising agency and a content distributor; and
the estimated price is derived based on the estimated statistics computed based on the one or more target users and the advertising period allocated based on the delivery parameters of the one or more constraints.

34. The method according to claim 33, wherein the content distributor is one of:
a content producer who distributes its own produced content;
a secondary distributor who receives content from another source and distributes the content;
a content portal who provides a gateway to content; and
a combination thereof.

35. The method according to claim 29, wherein the advertisement is delivered to each of the one or more target users during transmission of the content, whether before or after, or by interrupting the content, or by placing the advertised product or service in the content itself and by inserting the advertisement into the allocated advertising period.

36. The method according to claim 33, wherein the one or more constraints are provided by one of the advertiser, a content distributor, and a third party.

37. The method according to claim 29, wherein
the estimated price and the estimated statistics are received as a bid from a content distributor after an advertiser sends the one or more constraints related to the advertisement; and
the order placed corresponds to a best bid among one or more bids received from one or more content distributors receiving the one or more constraints for the advertisement.

38. The method according to claim 29, further comprising receiving feedback statistics after the advertisement is delivered to the target users.

39. The method according to claim 27, further comprising receiving an actual price wherein the actual price is derived by adjusting the estimated price based on the feedback statistics.

40. The method according to claim 28, wherein the feedback statistics comprise delivery statistics, which describe actual content with which the advertisement is delivered, actual delivery time, and actual amount of exposure of the advertisement.

41. The method according to claim 28, wherein the feedback statistics comprise derivative statistics, which indicate whether an existing advertisement is replaced by the advertising period.

42. The method according to claim 28, wherein the feedback statistics comprise user response statistics.

43. A method for a content distributor, comprising:
determining one or more target users or reception locations based on one or more constraints related to an advertisement;
estimating statistics based the on one or more target users or reception locations to whom an advertisement is to be delivered;
computing an estimated price for delivering the advertisement based on the estimated statistics;
sending, over a network, the estimated price and the estimated statistics, wherein
the one or more constraints define
desired characteristics of the one or more target users to whom the advertisement is to be delivered, and
delivery parameters based on which the advertisement is to be delivered to each of the one or more target users.

44. The method according to claim 43, wherein the advertisement is delivered using an advertising period.

45. The method according to claim 44, wherein the advertising period is allocated based on the delivery parameters.

46. The method according to claim 45, wherein the advertising period is allocated in content to be delivered to a target user.

47. The method according to claim 43, wherein the content distributor is one of:
a content producer who distributes its own produced content;
a secondary distributor who receives content from another source and distributes the content;
a content portal who provides a gateway to content; and
a combination thereof.

48. The method according to claim 43, wherein the estimated price and the estimated statistics are sent to one of:
an advertiser including one of:
an advertising agency,
a business entity,
an organization, and
an individual; and
a user of the content distributor.

49. The method according to claim 43, wherein the estimated price and the estimated statistics are sent to a plurality of advertisers to solicit purchasers.

50. The method according to claim 44, wherein
the advertising period is embedded in the content to be transmitted to each of the one or more target users; and
the advertisement is delivered to each of the one or more target users during transmission of the content, whether before or after, or by interrupting the content, or by placing the advertised product or service in the content itself and by inserting the advertisement into the advertising period.

51. The method according to claim 43, wherein said determining comprises:
searching information related to a plurality of individuals, each having a profile; and
selecting the one or more target users by comparing the one or more constraints to the profiles of the plurality of individuals and identifying the target users whose profiles match the one or more constraints.

52. The method according to claim 46, further comprising allocating, based on the one or more constraints, the advertising period in content scheduled to be transmitted to a target user.

53. The method according to claim 52, wherein said allocating the advertising period for a target user comprises:
retrieving a delivery schedule for the target users;
identifying content scheduled to be transmitted to the target user at a time satisfying a constrained advertisement delivery time specified in the one or more constraints; and
allocating the advertising period in the identified content based on an advertisement exposure requirement specified in the one or more constraints.

54. The method according to claim 43, wherein the estimated statistics include at least one of:
number of the one or more target users;
a measure characterizing a degree of match between each target user's profile and the one or more constraints;
a measure characterizing a degree of match between the delivery schedule by which the advertisement is to be delivered to the one or more target users and the specified delivery parameters.

55. The method according to claim 54, wherein a delivery schedule for a target user includes at least one of:
a destination for the delivery;
content to be delivered to the target user;
a delivery time by which the content is to be delivered to the target user;
an amount of each single exposure;
a repetition rate of exposure in the content; and
a derivative status indicating whether the advertisement is performed by replacing an existing advertisement.

56. The method according to claim 43, wherein said computing the estimated price comprises:
determining an overall desirability for each of the target users from both the advertiser's perspective and the content distributor's perspective;
calculating an individual price for delivering the advertisement to each of the one or more target users based on the overall desirability of the target user; and
computing the estimated price for delivering the advertisement to the one or more target users based on the calculated individual prices.

57. The method according to claim 43, further comprising delivering, after receiving an order for the advertising period over a network, the advertisement to the one or more target users.

58. The method according to claim 57, wherein the advertisement is delivered during transmission of content using an advertising period allocated in the content to each of the target users.

59. The method according to claim 57, wherein the advertisement is delivered to a target users in a media form determined based on a specific device on which the target user is to receive the advertisement and the media form includes at least one of multimedia, video, audio, text, paper, and any combination thereof.

60. The method according to claim 57, further comprising receiving feedback statistics after the delivering the advertisement.

61. The method according to claim 60, wherein the feedback statistics include at least one of delivery statistics, derivative statistics, and user response statistics.

62. The method according to claim 61, wherein the delivery statistics include actual content with which the advertisement is delivered, actual delivery time, and actual amount of exposure of the advertisement.

63. The method according to claim 56, further comprising:
generating an actual price for delivering the advertisement to the one or more target users by adjusting the estimated price based on the received feedback statistics; and
sending the actual price and the feedback statistics to an advertiser who ordered the delivery.

64. A method for pricing individualized advertising, comprising:
receiving one or more constraints to be used in determining one or more target users or reception locations to which the advertisement is to be delivered;
selecting the one or more target users by comparing the one or more constraints to profiles of a plurality of individuals and identifying target users or reception locations whose profiles match the one or more constraints; and
calculating a price for delivering the advertisement to the one or more target users or reception locations based on statistics computed based on a degree of match between the one or more target users or reception locations and the one or more constraints, wherein
the one or more constraints define
desired characteristics of the one or more target users or reception locations to which the advertisement is to be delivered, and
delivery parameters based on which the advertisement is to be delivered to each of the one or more target users or reception locations.

65. The method according to claim 64, wherein said calculating the price comprises:
determining an overall desirability for each of the target users;
calculating an individual price for delivering the advertisement to each target user based on the overall desirability of the target user and a delivery schedule for delivering the advertisement to the target user; and
calculating the price for delivering the advertisement to the one or more target users based on the calculated individual prices, wherein
the overall desirability is determined based on both the perspective of a content distributor who is to deliver the advertisement to the target users and the perspective of an advertiser who desires to deliver the advertisement to target users who satisfy the one or more constraints.

66. The method according to claim 65, wherein said determining an overall desirability of a target user comprises:
accessing an index value associated with the target user with respect to each of the constraints, wherein the index value indicates the desirability of the target user from the content distributor's perspective;
retrieving a coefficient value, specified by the advertiser, with respect to each of the constraints, wherein the coefficient value indicates the desirability of the constraint from the advertiser's perspective; and
computing the overall desirability for the target user based on the index value and the coefficient value associated with the target user with respect to each of the constraints.

67. The method according to claim 65, wherein said calculating an individual price for delivering the advertisement to a target user comprises:
determining a unit price for delivering the advertisement to each of the target users based on a delivery schedule for the target user;
determining a total exposure amount by which the advertisement is to be exposed to the target user; and
computing the individual price based on the overall desirability of the target user, the unit price, and the total exposure amount.

68. A method for adjusting an estimated price for delivering an advertisement using an advertising period, comprising:
receiving feedback statistics relating to and after delivering the advertisement using the advertising period to one or more target users or reception locations during transmission of content;
adjusting the estimated price based on the feedback statistics to produce an actual price, wherein
the one or more target users are determined based on one or more constraints which define:
desired characteristics of the one or more target users or reception locations to which the advertisement is to be delivered, and
delivery parameters based on which the advertisement is to be delivered to each of the one or more target users.

69. The method according to claim 68, wherein the one or more constraints comprise at least one of a demographic constraint, a program constraint, a time constraint, an institutional constraint, a derivative constraint, and a receiving device constraint.

70. The method according to claim 69, wherein the demographic constraint includes at least one of gender, income, hobby, age, and the number of targeted users at a reception location.

71. The method according to claim 69, wherein the time constraint specifies delivery parameters, which include at least one of a time frame within which the order for the advertisement is to be completed, number of programs with which the advertisement is to be delivered, desired delivery time, amount of each single exposure, and a repetition rate of exposure.

72. The method according to claim 69, wherein the derivative constraint specifies whether the advertising period can be allocated in replacement of an existing advertisement or whether the advertisement to be inserted in the advertising slot can be replaced by another advertisement.

73. The method according to claim 68, wherein the estimated price is computed based on estimated statistics relating to the one or more target users and delivery schedule by which the advertisement is delivered to the target users.

74. The method according to claim 68, wherein the feedback statistics include at least one of delivery statistics, derivative statistics, and user response statistics.

75. The method according to claim 74, wherein the delivery statistics include actual content with which the advertisement is delivered, actual delivery time, and actual amount of exposure of the advertisement.

76. The method according to claim 68, wherein said adjusting comprises:
identifying a discrepancy between the estimated statistics and the feedback statistics;
and generating the actual price based on the estimated price and the discrepancy.

77. The method according to claim 76, wherein the discrepancy includes at least one of:
a difference between estimated content and actual content with which the advertisement is delivered;
a difference between the estimated one or more target users or reception locations and actual target users or reception locations to which the advertisement is delivered;
a difference between an estimated time and an actual time by which the advertisement is delivered;
a difference between an estimated length in time and an actual length in time during which the actual target users are exposed to a single impression of the advertisement;
a difference between an estimated repetition rate and an actual repetition rate by which the actual target users are exposed to the advertisement; and
a difference between an estimated allocation and an actual allocation of the advertising period through which the advertisement is delivered to the actual target users.

78. The method according to claim 77, wherein the estimated allocation is specified as at least one of:
the advertising period is to replace an advertisement existing in the content;
the advertising period is not to replace an advertisement existing in the content;
the advertising period, once allocated, is not to be replaced by another advertisement; and
the advertising period, once allocated, can be replaced by another advertisement.

79. A system for advertising, comprising:
a content distributor configured to offer at an estimated price to deliver an advertisement;
an advertiser capable of placing an order with the content distributor for delivering the advertisement at the estimated price; and
one or more target users or reception locations to which the advertiser desires to deliver and the content distributor delivers the advertisement, wherein
the one or more target users or reception locations are determined according to one or more constraints which define:
desired characteristics of the one or more target users or reception locations to which the advertisement is to be delivered, and
delivery parameters based on which the advertisement is to be delivered to each of the one or more target users or reception locations, and
the estimated price is determined based on estimated statistics computed based on a degree of match between the one or more target users or reception locations and the one or more constraints.

80. The method according to claim 79, wherein the advertisement is delivered using an advertising period.

81. The method according to claim 80, wherein the advertising period is allocated based on the delivery parameters.

82. The method according to claim 81, wherein the advertising period is allocated in content to be delivered to a target user.

83. The system according to claim 79, wherein the content distributor is one of:
a content producer who distributes its own produced content;
a secondary distributor who receives content from another source and distributes the content;
a content portal who provides a gateway to content; and
a combination thereof.

84. The system according to claim 79, wherein the one or more constraints are received from one of:
an advertiser including one of:
an advertising agency,
a business entity,
an organization, and
an individual; and
a user of the content distributor.

85. The system according to claim 82, wherein
the advertising period is embedded in the content to be transmitted to each of the one or more target users; and
the advertisement is delivered to each of the one or more target users during transmission of the content by inserting the advertisement into the advertising period.

86. The system according to claim 79, wherein the one or more constraints include at least one of a demographic constraint, a geographic constraint, a time constraint, a program constraint, an institutional constraint; a derivative constraint, and a receiving device constraint.

87. The system according to claim 79, wherein the content distributor comprises:
a target user matching mechanism configured to identify the one or more target users based on the one or more constraints;
an advertising period allocator configured to allocate the advertising period in the content based on the one or more constraints; and
a pricing mechanism configured to derive the estimated price based on the estimated statistics.

88. The system according to claim 87, further comprising a delivery scheduler configured to produce a delivery schedule of each of the one or more target users, wherein the delivery schedule is used in allocating the advertising period.

89. The system according to claim 88, further comprising a delivery mechanism configured to transmitting content and/or advertisement to the one or more target users according to the delivery schedules.

90. The system according to claim 88, further comprising:
a feedback receiver configured to receive feedback statistics after delivering the advertisement to the one or more target users; and
a price adjuster configured to adjust the estimated price based on the feedback statistics to produce an actual price.

91. The system according to claim 79, wherein the advertiser comprises:
an advertising soliciting mechanism configured to solicit an offer for delivering the advertisement; and
an advertising ordering mechanism configured to accept an offer for delivering the advertisement, wherein the offer provides the estimated price with the estimated statistics characterizing the one or more target users and offered delivery schedules by which the advertisement is transmitted to the one or more target users.

92. The system according to claim 91, further comprising a constraint generation mechanism configured to generate, prior to soliciting the offer, the one or more constraints to be used in determining the one or more target users.

93. A system for a content distributor, comprising:
an information processor configured to receive and to process one or more constraints;
a target user matching mechanism configured to identify one or more target users or reception locations based on the one or more constraints;
a pricing mechanism configured to derive an estimated price to deliver the advertisement using the advertising period to the one or more target users or reception locations during transmission of content, wherein the one or more constraints define
desired characteristics of the one or more target users or reception locations to which the advertisement is to be delivered, and
delivery parameters based on which the advertisement is to be delivered to each of the one or more target users or reception locations, and
the estimated price is determined based on estimated statistics computed based on the one or more target users or reception locations and the one or more constraints.

94. The method according to claim 93, further comprising an advertising period allocator configured to allocate an advertising period in content for an advertisement based on the one or more constraints.

95. The system according to claim 93, wherein the pricing mechanism comprises:
an individual delivery price estimator configured to calculate an individual price for delivering the advertisement to one of the one or more target users based on an overall demand for the target user and a delivery schedule to deliver content to the target user; and
a total delivery price estimator configured to compute the estimated price for delivering the advertisement to the one or more target users based on the individual prices computed with respect to delivering the advertisement to each of the one or more target users.

96. The system according to claim 93, further comprising a delivery scheduler configured to produce a delivery schedule of each of the one or more target users, wherein the delivery schedule is used in allocating the advertising period and in determining the estimated price.

97. The system according to claim 96, further comprising a delivery mechanism configured to transmitting the advertisement and/or content embedded with the advertising period inserted with the advertisement to the one or more target users according to the delivery schedule.

98. The system according to claim 96, further comprising:
a feedback receiver configured to receive feedback statistics after delivering the advertisement to the one or more target users; and
a price adjuster configured to adjust the estimated price based on the feedback statistics to produce an actual price.

99. A system for an advertiser, comprising:
an advertising soliciting mechanism configured to solicit, over a network, an offer for delivering an advertisement; and
an advertising ordering mechanism configured to accept, over the network, an offer for delivering the advertisement at an estimated price to deliver the advertisement to one or more target users during transmission of content, wherein
the one or more target users are determined based on one or more constraints which define
desired characteristics of the one or more target users to whom the advertisement is to be delivered, and
delivery parameters based on which the advertisement is to be delivered to each of
the one or more target users, and
the estimated price is offered with estimated statistics characterizing the one or more target users and an offered delivery schedule by which the advertisement is to be delivered.

100. The system according to claim 99, further comprising a constraint generation mechanism configured to generate, prior to soliciting the offer, the one or more constraints to be used in determining the one or more target users and the offered delivery schedule.

101. The system according to claim 100, wherein the estimated price is determined based on the estimated statistics computed based on the one or more target users and the one or more constraints.

102. A system for computing a price for delivering an advertisement, comprising:
a target user matching mechanism configured to identify one or more target users based on one or more constraints; and
a pricing mechanism configured to derive an estimated price for delivering the advertisement using the advertising period to the one or more target users during transmission of content, wherein
the one or more constraints define
desired characteristics of the one or more target users to whom the advertisement is to be delivered, and
delivery parameters based on which the advertisement is to be delivered to each of
the one or more target users, and
the estimated price is derived based on estimated statistics characterizing the one or
more target users and a delivery schedule by which the advertisement is to be delivered.

103. The method according to claim 102, further comprising an advertising period allocator configured to allocating the advertising period based on the one or more constraints.

104. The system according to claim 102, wherein the pricing mechanism comprises:
an individual delivery price estimator configured to calculate an individual price for delivering the advertisement to one of the one or more target users based on an overall desirability for the target user and a delivery schedule to deliver content to the target user; and
a total delivery price estimator configured to compute the estimated price for delivering the advertisement to the one or more target users based on the individual prices computed with respect to each of the one or more target users.

105. The system according to claim 104, further comprising:
a demand index retriever configure to access an index value associated with a target user with respect to each of the one or more constraints;
a coefficient retriever configured to retrieve a coefficient value with respect to each of the one or more constraints, wherein the overall demand for the target user is computed based on the index value associated with the target user and the coefficient value with respect to each of the one or more constraints, wherein
the index value indicates the desirability of the target user having a feature meeting one of the constraint from the content distributor's perspective, and
the coefficient value indicates the desirability of the feature from the advertiser's perspective.

106. A system for adjusting a price for delivering an advertisement using an advertising period, comprising:
a feedback receiver configured to receive feedback statistics characterizing a delivery of the advertisement to one or more target users or reception locations using the advertising period during transmission of content; and
a price adjuster configured to adjust the price based on the feedback statistics to produce an actual price, wherein
the price is estimated prior to the delivery based on estimated statistics characterizing projected target users or reception locations determined based on one or more constraints and a projected delivery schedule, which define
desired characteristics of the one or more target users to whom the advertisement is to be delivered, and
delivery parameters based on which the advertisement is to be delivered to each of the one or more target users, and
the price is adjusted based on at least one of a discrepancy between the projected target users and the one or more target users to whom the advertisement is actually delivered and a discrepancy between the projected delivery schedule and the delivery carried out and if the advertiser has paid for the advertisement prior to determination of the actual price, providing a rebate or credit to the advertiser when the actual price is less than the amount paid.

107. The system according to claim 106, wherein the feedback statistics include at least one of delivery statistics, derivative statistics, and user response statistics.

108. The method according to claim 107, wherein the delivery statistics include actual content with which the advertisement is delivered, actual delivery time, and actual amount of exposure of the advertisement.
